(19) United States
(12) Patent Application Publication
(10) Pub. No.: US 2016/0130533 A1
(43) Pub. Date: May 12, 2016

(54) LATEX ADDITIVES

(71) Applicant: REVOLYMER (UK) LIMITED, Flintshire (GB)

(72) Inventors: Thomas Charles CASTLE, Flintshire Clwyd (GB); David Alan PEARS, Flintshire Clwyd (GB); Maurice PRESTON, Flintshire Clwyd (GB); Pennadam Shanmugam SIVANAND, Flintshire Clwyd (GB)

(21) Appl. No.: 14/891,960

(22) PCT Filed: May 16, 2014
(86) PCT No.: PCT/GB2014/051502

§ 371 Date: Nov. 17, 2015

(30) Foreign Application Priority Data
May 17, 2013 (GB) 1308916.4

(51) Int. Cl. C11D 3/37; C11D 3/00

(52) U.S. Cl. CPC C11D 3/3788; C11D 3/0036

(57) ABSTRACT

A latex composition including a dispersion of an amphiphilic copolymer in an aqueous medium, wherein the copolymer is: (i) a graft copolymer including a hydrophobic straight or branched chain carbon-carbon backbone having at least one hydrophilic side chain, wherein each chain is independently of formula (I), wherein R1 and R2 are each independently H1-C(O)WR4 or —C(O)Q; provided that at least one of R1 and R2 is the group —C(O)Q; or R1 and R2 together form a cyclic structure together with the carbon atoms to which they are attached.

The present invention relates to a latex composition suitable for use as an additive in industrial and institutional cleaners.

### BACKGROUND TO THE INVENTION

Hard surfaces are encountered in a wide range of industrial and institutional situations ranging from food processing and handling, hospitals and health care (surgical instrument cleaners), engineering industry (e.g. spray washing of equipment and surface treatments), shops, care homes, the transport industry (road, rail, marine and aviation). Buildings used by businesses, charities, institutions such as hospitals and other organisations present an array of different hard surfaces that users encounter. These range from flooring and windows in office buildings to bathroom tiles and laminates in the instance of a hotel. Products for cleaning such environments range from floor and toilet cleaners to heavy duty degreasers It is important not only that an appropriate level of cleanliness is maintained on such surfaces, but that employees, guests and visitors get the sensorial impression that cleanliness is being maintained on these surfaces.

The use of certain polymeric species in hard surface cleaning products is already known in the art. For example, WO 97/43372 (S.C Johnson & Son, Inc.) discloses a rinsable hard surface cleaner containing a silicate, a hydrophobic acrylic polymer and a surfactant. Likewise, WO 2009/023209 (S.C Johnson & Son, Inc.) discloses hard surface cleaning compositions comprising hydrophilic polymers, at least one non-ionic surfactant, at least one solvent, an acid and water, wherein the acid provides the composition with a pH of about 2 to 3.5, and the composition is provided in the absence of any anionic, cationic or amphoteric surfactant. The hydrophilic polymer comprises an acidic monomer having (or capable of forming) an anionic charge, a monomer having a permanent cationic charge (or capable of forming a cationic charge upon protonation), and optionally, a monomer having a neutral charge. Suitable hydrophilic polymers include quaternized ammonium acrylamide acrylic acid copolymers.

The present invention seeks to provide new additives suitable for use in hard surface cleaning compositions, for instance for industrial and institutional use. In a preferred embodiment, the invention provides additives for use in hard surface cleaning compositions that make surfaces easier to clean by preventing the re-deposition of dirt during the cleaning cycle and/or by enhancing the visual appearance (i.e. gloss) and odour of the surfaces being cleaned.

### STATEMENT OF INVENTION

A first aspect of the invention relates to a latex composition comprising a dispersion of an amphiphilic copolymer in an aqueous medium, wherein the amphiphilic copolymer is:

(i) a graft copolymer comprising a hydrophobic straight or branched chain carbon-carbon backbone having at least one hydrophilic side chain, wherein each hydrophilic side chain is independently of formula (I),

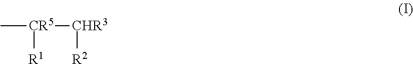

wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II)

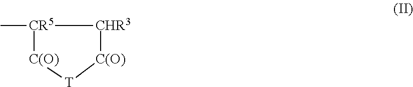

wherein:
R³ and R⁵ are each independently H or alkyl;

### W is O or NR⁴;

Q is a group of formula —X¹—Y—X²P;
T is a group of formula —N—Y—X²—P;
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group; or
(ii) an amphiphilic copolymer of general formula (I′):

B—(OR′)ₓ (I′)

wherein B is a straight or branched chain polymer backbone which is a copolymer of at least one ethylenically-unsaturated hydrocarbon monomer comprising at least 2 carbon atoms and maleic anhydride (MA) and each OR′ is a hydrophilic side chain attached to the backbone, wherein x denotes the number of side chains and is in the range 1 to 5000.

The present applicant has found that latex compositions comprising amphiphilic copolymers containing both hydrophobic and hydrophilic regions have a utility in hard surface cleaning products. Advantageously, the amphiphilic copolymer-containing latex compositions impart increased gloss to surfaces, making them easier to clean, as well as enhanced retention of benefit agents. The presence of these amphiphilic copolymers can also control how slippery a surface is. The hard surface cleaning (HSC) products can take a variety of forms including sprays, cleaning fluids and bucket-dilutable cleaners, and may be used in industrial and institutional cleaning products.

A second aspect of the invention relates to the use of a latex composition comprising a dispersion of an amphiphilic copolymer in an aqueous medium, wherein the amphiphilic copolymer is:

(i) a graft copolymer comprising a hydrophobic straight or branched chain carbon-carbon backbone having at least one hydrophilic side chain, wherein each hydrophilic side chain is independently of formula (I),

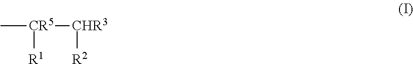

wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II)

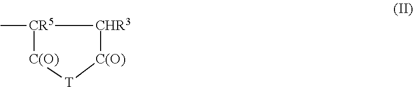

wherein:
R³ and R⁵ are each independently H or alkyl;

### W is O or NR⁴;

Q is a group of formula —X¹—Y—X²P;
T is a group of formula —N—Y—X²—P,
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group; or
(ii) a graft copolymer of general formula (I′):

B—(OR′)ₓ (I′)

wherein B is a straight or branched chain polymer backbone which is a copolymer of at least one ethylenically-unsaturated hydrocarbon monomer comprising at least 2 carbon atoms and maleic anhydride and each OR′ is a hydrophilic side chain attached to the backbone, wherein x denotes the number of side chains and is in the range 1 to 5000;
as an additive in a hard surface cleaning composition for industrial and institutional use.

The invention also relates to a latex composition, process and use as substantially described herein.

### DETAILED DESCRIPTION

As used herein, the term “latex” refers to a dispersion or emulsion of one or more copolymers described herein in an aqueous medium, wherein the material is present in the form of a colloid with a small particle size.

As used herein, the term “aqueous medium” refers to a medium that contains water, or is water, or is water-based or is a mixture of water and other co-solvents, e.g. water miscible co-solvents. In one particularly preferred embodiment, the aqueous medium is water. In another highly preferred embodiment, the aqueous medium is a purified or treated water, for example, deionized water.

The term “latex composition” refers to a composition comprising a latex as described herein.

Other components may also be present in the latex and/or the composition as a whole and/or the aqueous medium, for example, one or more of the following: a surfactant, an organic solvent, a defoaming agent, an antimicrobial agent, an antioxidant, a buffering agent, a neutralising agent, a plasticizer and a stabilizer.

As used herein, the term “copolymer” refers to a polymeric system in which two or more different monomers are polymerised together.

As used herein, the term “amphiphilic copolymer” refers to a copolymer in which there are clearly definable hydrophilic and hydrophobic portions.

By way of illustration, particularly preferred amphiphilic copolymers suitable for use in the present invention comprise hydrophilic grafts connected to a hydrophobic backbone by means of maleic anhydride or one of its esters. The grafts preferably have SH, OH, NH₂ functionality.

The amphiphilic copolymers include those having backbones in which the maleic anhydride is pendant or dangling from the backbone, for example:

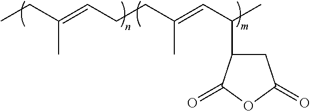

as well as those in which the maleic anhydride is copolymerised into the backbone itself, for example:

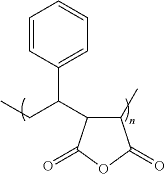

Further details of amphiphilic copolymers suitable for use in the context of the present invention are described in WO 2006/016179, WO 2009/050203, WO 2009/068569, WO 2009/068570 all of which are incorporated by reference, and in the paragraphs below.

As used herein, the term “alkyl” encompasses a linear or branched alkyl group, preferably containing 1 to 20 carbon atoms, more preferably 1 to 10 carbon atoms, and even more preferably 1 to 5 carbon atoms. Examples include, but are not limited to, methyl, ethyl, isopropyl, n-propyl group, n-butyl, sec-butyl, tert-butyl group and pentyl.

As used herein, the term “aryl” refers to a C₆₋₂₀ aromatic group, more preferably, a C₆₋₁₂ aromatic group. Examples include, but are not limited to, phenyl, benzyl, toluyl and napthyl.

As used herein, the term “heteroaryl” refers to a C₂₋₂₀ aromatic group, more preferably, a C₂₋₁₂ aromatic group, which comprises one or more heteroatoms. Preferably, the heteroaryl group is a C₄₋₁₂ aromatic group comprising one or more heteroatoms selected from N, O and S. Examples of heteroaryl groups include, but are not limited to, pyrrole, pyrazole, pyrimidine, pyrazine, pyridine, quinoline, thiophene, 1,2,3-triazole, 1,2,4-triazole, thiazole, oxazole, iso-thiazole, iso-oxazole, imidazole, furan and the like.

The compositions of the present invention comprise at least one amphiphilic copolymer. In one embodiment, the composition of the present invention comprises from 1 to 4 amphiphilic copolymers, for example 1, 2, 3, or 4 copolymers, preferably one or two copolymers, most preferably one copolymer.

In one preferred embodiment of the invention, the amphiphilic copolymer has a hydrophilic-lyphophilic (or hydrophobic) balance (HLB) as measured by Griffin's method of less than or equal to about 15, preferably less than or equal to about 10, more preferably between about 1 and about 10, yet more preferably between about 2 and about 9, for example, between about 3 and about 8. The Griffin method values are calculated by: hydrophilic-lyphophilic balance=20×molecular mass of the hydrophilic portion/molecular mass of the whole molecule.

The molecular mass of the hydrophilic and hydrophobic portions of the polymer can be estimated from the quantities of the relevant monomers put in as feedstocks in the amphiphilic copolymer's manufacture and an understanding of the kinetics of the reaction. The composition of the final product can be checked by comparing the relevant intensities of signals from each block or portion using ¹H nuclear magnetic resonance spectroscopy. Alternatively any other quantitative spectroscopic technique such as infra-red spectroscopy or ultra-violet visible spectroscopy may be used to confirm the structure, provided the different portions give clearly identifiable and measurable contributions to the resulting spectra. Gel permeation chromatography (GPC) may be used to measure the molecular weight of the resulting materials (as described in the accompanying Examples section).

Further details of suitable amphiphilic copolymers of this type are described in WO 2006/016179, WO 2009/050203 and WO 2009/068569, all of which are hereby incorporated by reference.

In one preferred embodiment, the amphiphilic copolymer is a graft copolymer comprising a hydrophobic straight or branched chain carbon-carbon backbone having at least one hydrophilic side chain, wherein each hydrophilic side chain is independently of formula (I),

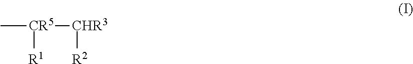

wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II)

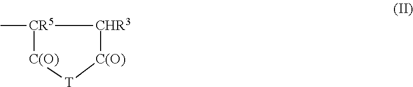

wherein:
R³ and R⁵ are each independently H or alkyl;

### W is O or NR⁴;

Q is a group of formula —X¹—Y—X²P;
T is a group of formula —N—Y—X²—P;
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

In a preferred embodiment of the invention, the hydrophilic polymeric group Y is a poly(alkylene oxide), polyglycidol, poly(vinyl alcohol), poly(ethylene imine), poly(styrene sulphonate) or poly(acrylic acid). More preferably, the hydrophilic polymeric group Y is a polyalkylene oxide, such as polyethylene oxide or a copolymer thereof.

In a further preferred embodiment of the invention, the hydrophilic polymeric group Y is of formula -(Alk¹-O)_{b}-(Alk²-O)_{c}—, wherein Alk¹ and Alk² are each independently an alkylene group having from 2 to 4 carbon atoms, and b and c are each independently an integer from 1 to 125; provided that the sum b+c has a value in the range of from about 10 to about 250, more preferably, from about 10 to about 120.

In a further preferred embodiment of the invention, the graft copolymer has from 1 to 5000, preferably from about 1 to about 300, and more preferably from about 1 to about 150, pendant hydrophilic groups attached thereto. For example, the graft copolymer may have between about 1 to about 10, between about 1 to about 5, or between about 2 to about 8 pendant hydrophilic groups attached thereto.

Each side chain of the graft polymer preferably has a molecular weight from about 800 to about 10,000. For example, each side chain may have a molecular weight between about 1000 to about 7500, between about 2500 to about 5000 or between about 6000 and about 9000.

A graft copolymer is typically produced by the reaction of hydrophilic grafts with a reactive group at a single site on the carbon-carbon backbone, i.e. the reaction uses monofunctional grafts. In order to create a cross-linked or chain extended copolymer it is necessary to incorporate a hydrophilic graft that has two sites that will react with the carbon-carbon backbone; i.e. a difunctional hydrophilic graft that can act as a cross-linking agent is used.

Preferably, the cross-linked or chain extended copolymers comprise a linear or branched carbon-carbon backbone and a difunctional graft or a mixture of monofunctional and difunctional grafts. More preferably, the cross-linked or chain extended copolymers comprise a carbon-carbon backbone functionalized with maleic anhydride or a derivative thereof (as described herein) and an alkylene oxide such as those described in formula (II). Most preferably, the cross-linked or chain extended copolymers comprise a carbon-carbon backbone derived from polyisoprene or polybutadiene functionalized with maleic anhydride or a derivative thereof, and further comprise hydrophilic grafts being polyethylene oxide or a copolymer thereof.

In one preferred embodiment of the invention, the carbon-carbon polymer backbone is derived from a homopolymer of an ethylenically-unsaturated polymerizable hydrocarbon monomer or from a copolymer of two or more ethylenically-unsaturated polymerizable hydrocarbon monomers.

More preferably, the carbon-carbon polymer backbone is derived from an ethylenically-unsaturated polymerizable hydrocarbon monomer containing 4 or 5 carbon atoms.

In one highly preferred embodiment of the invention, the carbon-carbon polymer backbone is derived from isobutylene, 1,3-butadiene, isoprene or octadecene, or a mixture thereof.

In one preferred embodiment of the invention, the copolymer comprises a carbon-carbon backbone (e.g. polyisoprene or polybutadiene) onto which maleic anhydride or maleic anhydride acid/ester groups have been grafted. Preferably, the carbon-carbon backbone comprises from about 1 to about 50 wt % maleic anhydride group. As known in the art, it will be possible to replace the maleic anhydride (MA) group with maleic acid and salts thereof and maleic acid ester and salts thereof and mixtures thereof. Unless otherwise noted, where maleic anhydride is referred to these groups may also usefully be used in its place in the invention to obtain substantially similar results.

Particularly preferred examples of polymers in which the maleic anhydride is grafted onto the polymeric backbone include poly(isoprene-graft-maleic anhydride) (PIP-g-MA)

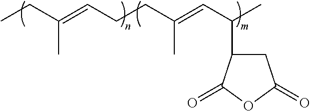

wherein each of m and n is independently an integer from 1 to 20 000. Preferably m is 1 to 1000, more preferably 1 to 100 and yet more preferably 10 to 50. Preferably n is 1 to 5000, more preferably 5 to 2000 and yet more preferably 10 to 1000. Preferably, m is 1 to 100 and n is 5 to 2000. Such polymers are available commercially from for instance Kuraray (sold under the name LIR-403) and the Sigma Aldrich company.

A further preferred example includes polyisoprene-graft-monoacid monomethyl ester (PIP-g-MaMme)

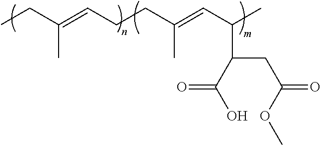

wherein each of m and n is as defined above. Such polymers are available commercially from for instance Kuraray (sold under the name LIR-410) and the Sigma Aldrich company.

Another preferred example includes poly(butadiene-graft-maleic anhydride) (PBD-g-MA)

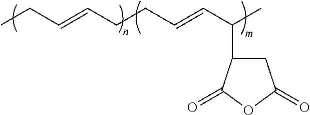

wherein each of m and n is as defined above. A range of polybutadiene polymers functionalised with maleic anhydride are sold under the Ricon brand by Sartomer (e.g. Ricon 130MA8) and Lithene by Synthomer (e.g. N4-5000-5MA).

The maleic anhydride group coupling chemistry provides a convenient method for attaching the grafts to the copolymer backbone. However, the skilled person would appreciate that other functional groups would be equally effective in this regard.

By way of example, the reaction of another acyl group (e.g. a suitable carboxylic acid or acyl chloride) with a hydroxyl functionalised polymer will be suitable for forming an ester linkage between the graft and backbone. Various strategies for performing coupling reactions, or click chemistry, are also known in the art and may be utilised by functionalising the backbone with suitable groups, possibly in the presence of a suitable catalyst. For instance the reaction of an alkyl or aryl chloride group on the backbone with a hydroxyl group for instance (i.e. a Williamson coupling), or the reaction of a silicon hydride with an allyl group (a hydrosilyation reaction) could be utilised.

In one preferred embodiment, the backbone of the amphiphilic polymer has a molecular weight from about 1,000 to about 10,000.

In one preferred embodiment of the invention, the amphiphilic polymer is of general formula (I′):

B—(OR′)ₓ (I′)

wherein B is a straight or branched chain polymer backbone which is a copolymer of at least one ethylenically-unsaturated hydrocarbon monomer comprising at least 2 carbon atoms and maleic anhydride, and each OR′ is a hydrophilic side chain attached to the backbone, wherein x denotes the number of side chains and is in the range 1 to 5000.

When referring to maleic anhydride in the backbone, it will be noted that we are referring to the units derived from maleic anhydride which are present in the copolymer or terpolymer. The “backbone” comprises the units derived from maleic anhydride together with units derived from the other monomers polymerised to make the backbone of the polymeric material. The “side chains” comprise the residual structure of the side chain precursors, after they have reacted with the copolymer or terpolymer backbone.

In this particular embodiment, the backbone is flexible and provides more points of attachment for side chains than the polymers in WO 2006/016179, which do not have maleic anhydride in the backbone per se. The polymer backbone may contain varying proportions of maleic anhydride. Consequently, it is possible to control the degree of derivatization with side chains more precisely than in the polymers in WO 2006/016179. This allows a greater control over the physical properties of the polymeric material. The ethylene comonomers in the polymer backbone help to increase the chemical stability of the backbone.

In one preferred embodiment, the at least one ethylenically-unsaturated hydrocarbon monomer comprises at least 3 carbon atoms.

In another preferred embodiment, the at least one ethylenically-unsaturated hydrocarbon monomer is an aliphatic hydrocarbon monomer.

In another preferred embodiment, the at least one ethylenically-unsaturated hydrocarbon monomer is an aromatic hydrocarbon monomer.

In one particularly preferred embodiment, the backbone is a copolymer formed from the polymerisation of three different monomers, for example, a terpolymer of maleic anhydride, ethylene and a further ethylenically unsaturated monomer. The term “terpolymer” falls within the scope of the term “copolymer”.

In one particularly preferred embodiment of the invention, the carbon-carbon backbone is a copolymer of:

(i) maleic anhydride, maleic acid or salts thereof or maleic acid ester or salts thereof or a mixture thereof; and
(ii) one or more ethylenically-unsaturated polymerizable monomers.

For this embodiment, the MA group monomer is thus present in the actual backbone itself, rather than pendant to it (see, for example, WO 2009/068570).

A number of such materials are available commercially, most typically obtained by the radical polymerisation of a mixture of a maleic anhydride group and one or more other ethylenically unsaturated monomers. It will be envisioned that any number of monomers, though most typically a mixture of a maleic anhydride group and one other monomer (to make a bipolymer) or two other polymers (to make a terpolymer) will be used.

Preferably, the maleic anhydride group monomer is maleic anhydride.

Preferably, the other monomer is ethylene, isobutylene, 1,3-butadiene, isoprene, methyl vinyl ether, a C10-C20 terminal alkene, such as octadecene, styrene, or a mixture thereof. Most preferably, the other monomer is isobutylene, octadecene or styrene.

The percentage of the monomers, and thus functionality in the resulting polymer, may be altered to provide optimal fit to the application. One advantage of backbones prepared by such a method is that they offer the potential for higher loadings of maleic anhydride potentially available for reaction with hydroxy, amine, or sulfide functionalised grafts (e.g. suitable PEOs, MPEOs or amine functionalised alkyl ethoxylates like certain Jeffamines).

In one preferred embodiment of the invention, the carbon-carbon backbone is an alternating copolymer, more preferably, an alternating copolymer of maleic anhydride, maleic acid or salts thereof or maleic acid ester or salts thereof and the ethylenically-unsaturated polymerizable monomer.

In one preferred embodiment of the invention, the backbone is an alternating copolymer prepared by mixing and subsequently polymerising equimolar quantities of a MA group and another monomer.

A particularly preferred backbone copolymer is poly(isobutylene-alt-maleic anhydride) (PIB-alt-MA):

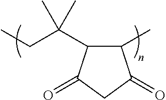

wherein n is from 5 to 4000, more preferably 10 to 1200.

This polymer is available commercially from Sigma-Aldrich and Kuraray Co. Ltd; Kuraray supply the material under the trade name ISOBAM.

A further preferred backbone copolymer is poly(maleic anhydride-alt-1-octadecene) (C18-alt-MA) (available from the Chevron Philips Chemical Company LLC and Sigma Aldrich).

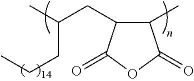

wherein n is from 5 to 500, more preferably 10 to 150.

Chevron Philips make a range of materials (both high and low viscosity) in their PA18 Polyanhydride resins range that are preferred backbones in the invention. PA18 is a solid linear polyanhydride resin derived from 1-octadecene and maleic anhydride in a 1:1 molar ratio.

A further preferred backbone copolymer is poly(styrene-alt-maleic anhydride) (PS-alt-MA:

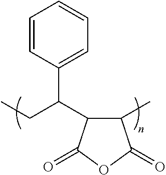

wherein n is from 5 to 500.

PS-alt-MA is available from a number of suppliers including Sartomer under the SMA trade name (e.g. SMA 1000F and SMA 1000P which are said to posses a Mₙ of 2,000 and M_{w} of 5,500).

Variants are also available in which the molar ratio of styrene to maleic anhydride varies from 1:1 are also available commercially and useful in the invention. For instance SMA 2000 F and P contains a 2:1 ratio of styrene to anhydride and SMA 3000 F and P contains a 3:1 ratio of styrene to anhydride. It will be understood by those skilled in the art these may best be described as statistical or random copolymers.

It will be appreciated by those skilled in the art that a number of other backbones in which maleic anhydride is included in the backbone, either by grafting the maleic anhydride as an adduct, or by copolymerising maleic anhydride with one or more other monomers that are useful in the invention.

A number of useful backbones are also manufactured by Kraton (e.g. Kraton FG) and Lyondell (e.g Plexar 1000 series) in which maleic anhydride is grafted onto polymers or copolymers of monomers such as ethylene, propylene, butylene, styrene and/or vinyl acetate. Poly(ethylene-alt-maleic anhydride) is available from a number of suppliers including Vertellus under the ZeMac trade name. Poly(methyl vinyl ether-alt-maleic anhydride) is available from International Speciality Products under the Gantrez trade name. Poly(ethylene-co-butyl acrylate-co-maleic anhydride) materials can be obtained from Arkema, and are sold under the trade name of Lotader (e.g. 2210, 3210, 4210, and 3410 grades). Copolymers in which the butyl acrylate is replaced by other alkyl acrylates (including methyl acrylate [grades 3430, 4404, and 4503] and ethyl acrylate [grades 6200, 8200, 3300, TX 8030, 7500, 5500, 4700, and 4720) are also available and also sold in the Lotader range. A number of the Orevac materials (grades 9309, 9314, 9307 Y, 9318, 9304, 9305) are suitable ethylene-vinyl acetate-maleic anhydride terpolymers.

In many cases in addition to, or instead of a maleic anhydride functionalised material a derivative a diacid, mono ester form, or salt is offered. As will be obvious to those skilled in the art many of these are also suitable in the invention.

Similarly, suitable side chains precursors are those discussed below, such as mono methoxy poly(ethylene oxide) (MPEO), poly(vinyl alcohol) and poly(acrylic acid). These may for instance be purchased from the Sigma-Aldrich company. Suitable polyethylene imines are available from BASF under the Lupasol trade name.

In one preferred embodiment, the amphiphilic copolymer is prepared by reacting a compound of formula (III),

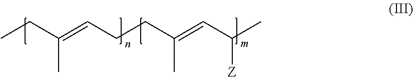

wherein Z is a group of the formula (IV),

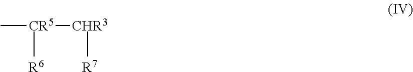

wherein R³ and R⁵ are each independently H or alkyl, and R⁶ and R⁷ are each independently H or an acyl group, provided that at least one of R⁶ and R⁷ is an acyl group, or R⁶ and R⁷ are linked to form, together with the carbon atoms to which they are attached, a group of formula (V),

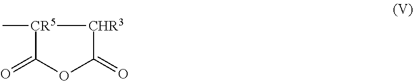

where n and m are each independently an integer from 1 to 20 000,
with a side chain precursor of formula (VI)

HX¹—Y—X²P (VI)

wherein:
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

Preferably m is 1 to 1000, more preferably 1 to 100 and yet more preferably 10 to 50. Preferably n is 1 to 5000, more preferably 5 to 2000 and yet more preferably 10 to 1000. Preferably, m is 1 to 100 and n is 5 to 2000.

In one preferred embodiment, the amphiphilic copolymer is prepared by reacting a compound of formula (IIIa),

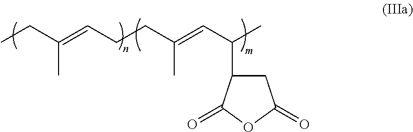

where n and m are as defined above, with a side chain precursor of formula (VI) as defined above.

In one preferred embodiment, the side chain precursor is of formula (VIa)

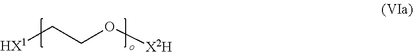

wherein X¹ is O or NH and X² is (CH₂)ₚ and o is an integer from 5 to 250, preferably 10 to 100.

In another preferred embodiment, the side chain precursor is of formula (VIb)

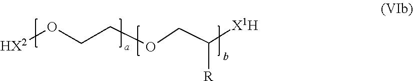

wherein R is H or alkyl, X¹ is O or NH and X² is (CH₂)ₚ and the sum of a and b is an integer from 5 to 600, preferably 10 to 100.

In one particularly preferred embodiment of the invention, the copolymer is prepared by grafting a monofunctional hydrophilic polymer such as poly(ethylene glycol)/poly(ethylene oxide) onto the maleic anhydride residues on the carbon-carbon backbone to form an amphiphilic copolymer of formula (VII),

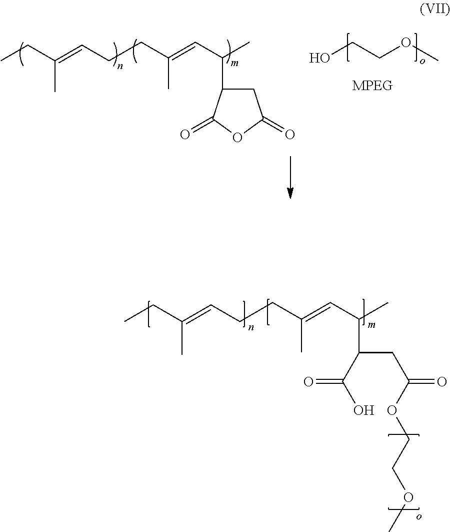

wherein each of m and n is independently an integer from 1 to 20 000. Preferably m is 1 to 1000, more preferably 1 to 100 and yet more preferably 10 to 50. Preferably n is 1 to 5000, more preferably 5 to 2000 and yet more preferably 10 to 1000. Preferably, m is 1 to 100 and n is 5 to 2000. Preferably o is an integer from 5 to 600, preferably 10 to 100.

The above example shows an alcohol functionalized PEO reacting with the maleic anhydride on a PIP-g-MA backbone. Suitable PIP-g-MA backbones are commercially available (for example, LIR-403 grade from Kuraray, which has approximately 3.5 MA units per chain).

Further details on functionalizing polyisoprene with maleic anhydride may be found in WO 2006/016179, WO 2008/104546, WO 2008/104547, WO 2009/68569 and WO 2009/68570, the contents of which are herein incorporated by reference.

In one preferred embodiment, the copolymer is prepared by adding a ratio of 2:8 equivalents of MPEO with respect to each maleic anhydride (MA) group. This essentially enables complete conversion of the maleic anhydride groups into the PEO functionalized esters.

In another preferred embodiment, the copolymer is prepared by adding a 1:1 ratio of methoxy poly(ethylene oxide) (MPEO) to maleic anhydride. After complete reaction of the MPEO, another (second) (dihydroxy) poly(ethylene oxide) (PEO) of any molecular weight (e.g. 2000, 4000, 6000, 8000 and 10000) can be added. It will be understood by those skilled in the art that MPEO, poly(ethylene oxide)methyl ether, methoxy poly(ethylene glycol) (MPEG), and poly(ethylene glycol)methyl ether are alternative methods of naming the same structure. Similarly PEO is also sometimes referred to as poly(ethylene glycol) (PEG) in the art. Some authors, for instance use the terms poly(ethylene glycol) and poly(ethylene oxide) to distinguish between different molecular weight polymer whilst acknowledging that they are chemically the same material. References to poly(ethylene oxide) may be interchanged with poly(ethylene glycol) throughout the text, and vice versa.

In addition to functionalising unreacted maleic anhydride units, it is also possible to graft PEO or another graft onto the corresponding diacid or a mono ester derivative of MA. This will result in new PEO ester links in the place of the COOH functionality. Two suitable backbones are illustrated below.

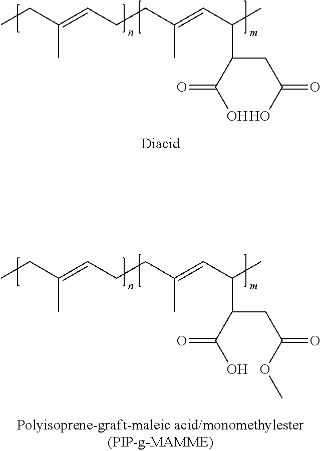

Thus, in one preferred embodiment, the amphiphilic copolymer is prepared by reacting a polymer precursor of formula (IIIb),

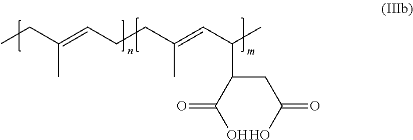

where n and m are as defined above, with a side chain precursor of formula (VI) as defined above.

In another preferred embodiment, the amphiphilic copolymer is prepared by reacting a polymer precursor of formula (IIIc),

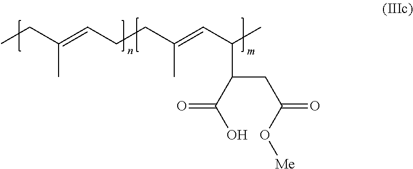

where n and m are as defined above, with a side chain precursor of formula (VI) as defined above.

In an alternative preferred embodiment, the copolymer of the invention is derived from —SH or nitrogen based (NH₂ or NHR) moieties.

In one particularly preferred embodiment, the copolymer comprises an NH₂ functionalized material. Preferably, for this embodiment, the amphiphilic copolymer is prepared from a side chain precursor of formula (VIc)

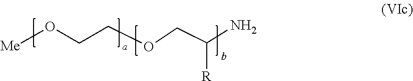

wherein R is H or alkyl, more preferably H or Me, and the sum of a and b is an integer from 5 to 250, preferably 10 to 100.

In one preferred embodiment, the amphiphilic copolymer is of formula (VIII):

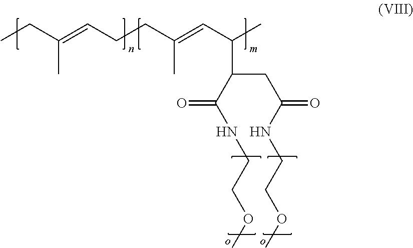

wherein m, n and o are as defined above. More preferably, the amphiphilic copolymer is of formulae (VIIIa) or (VIIIb) and is prepared by the following reaction:

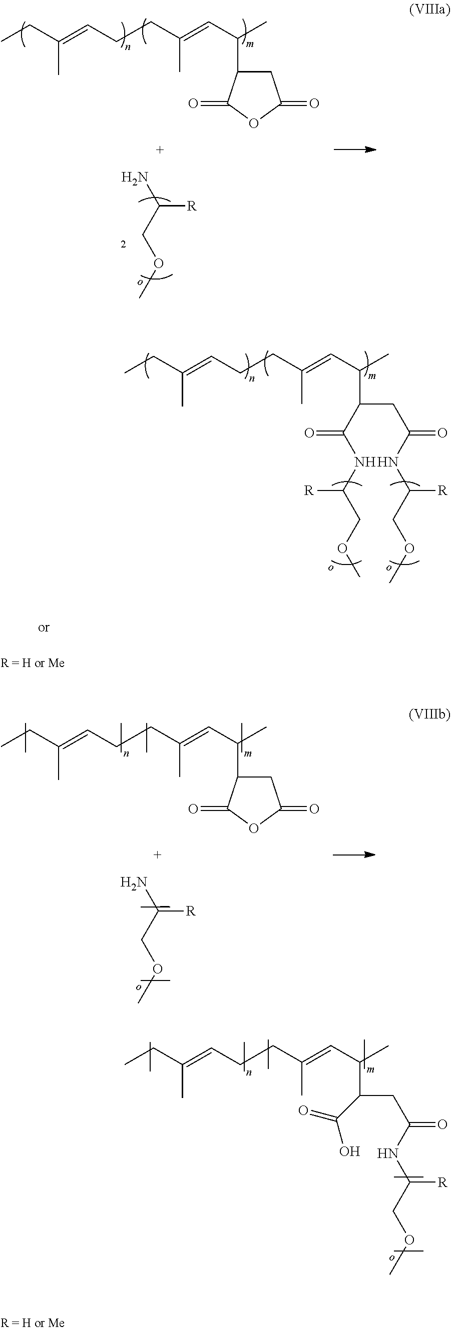

wherein each of m and n is independently an integer from 1 to 20 000.

Preferably, m is 1 to 1000, more preferably 1 to 100 and yet more preferably 10 to 50. Preferably, n is 1 to 5000, more preferably 5 to 2000 and yet more preferably 10 to 1000. Preferably, m is 1 to 100 and n is 5 to 2000. Preferably o is an integer from 5 to 600, preferably 10 to 100.

The NH₂ functionalized material depicted above comprises two grafts on each MA, which is not possible with MPEO. This is due to the greater reactivity of the NH₂ groups compared with OH. In addition to grafting two chains per maleic anhydride unit, the greater reactivity of the NH₂ units with respect to OH leads to a product containing very small quantities of free graft.

In any of the above embodiments, the compounds of formula (III) may be replaced by compounds of formulae (IX) and (X):

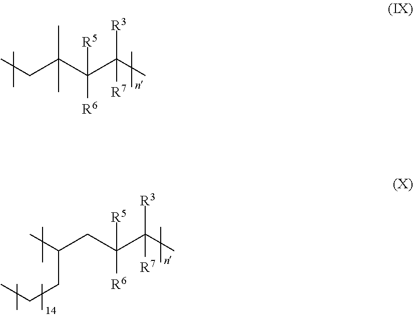

wherein n′ is 5 to 4000 and R³, R⁵, R⁶ and R⁷ are as previously defined.

Similarly, compounds of formulae (IIIa), (IIIb) and (IIIc) in any of the embodiments above may be replaced by compounds of formulae (IXa) or (Xa); (IXb) or (Xb); and (IXc) or (Xc), respectively:

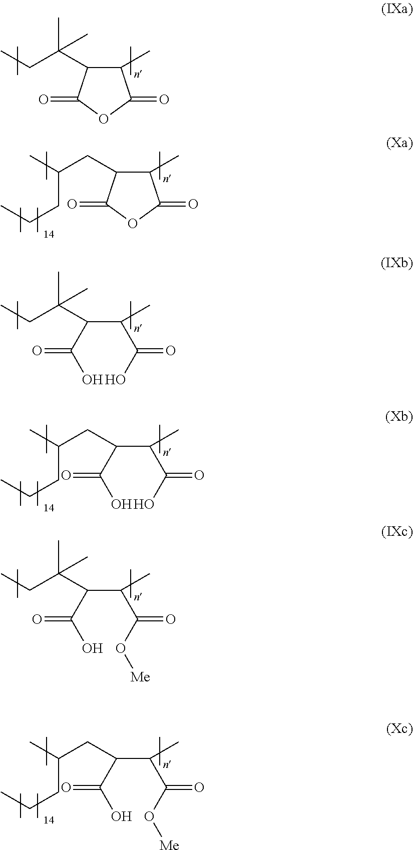

wherein n′ is as defined for compounds of formulae (IX) and (X).

In one preferred embodiment, the hydrophilic groups grafted onto the maleic anhydride groups are polymers of ethylene oxide (i.e. PEOs) copolymerised with propylene oxide. In this embodiment, the amount of propylene oxide is preferably between 1 and 95 mol percent of the copolymer, more preferably between 2 to 50 mol percent of the copolymer, and most preferably between 5 to 30 mol percent of the copolymer. Preferably, the side chain precursor is of formula,

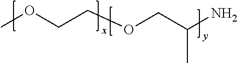

wherein x is 5 to 500, more preferably 10 to 100 and y is independently 1 to 125, more preferably 3 to 30. Preferably, x+y=6 to 600, more preferably 13 to 130. The distribution of ethylene and propylene oxide units may be in the form of blocks as depicted above or as a statistical mixture. In any case the molar ratio of ethylene oxide to propylene oxide in the copolymer will favour ethylene oxide. Such side chain precursors are sold commercially by Huntsman under the Jeffamine name.

Alternatively, it is possible to use a polymer that has two rather than one functional (e.g. OH, NH₂) units rather than one, in which both groups can react with the maleic anhydride. If these maleic anhydride groups are on different backbones, a cross-linked (or network) polymer can be formed. By controlling the ratio of graft to backbone, or by using mixtures with mono-functionalised materials, the degree of cross-linking can be controlled. Thus, it is possible to produce a material that resembles a chain extended graft copolymer (i.e. 2 or 3 graft copolymers) rather than a network by using a mixture of PEO and MPEO which chiefly comprises MPEO.

In one particularly preferred embodiment, the amphiphilic copolymer is prepared from a mixture of PIP-g-MA (polyisoprene with grafted maleic anhydride) together with MPEO (methoxy poly(ethylene oxide) and/or PEO poly(ethylene oxide). Preferably, the MPEO and PEO each have a molecular weight of about 2000.

In one particularly preferred embodiment, the amphiphilic copolymer is prepared from a mixture of PIP-g-MaMme (polyisoprene with grafted maleic monoacid monoester) together with MPEO (methoxy poly(ethylene oxide)) and/or PEO (poly(ethylene oxide)). Preferably, the MPEO and PEO each have a molecular weight of about 2000.

In one highly preferred embodiment of the invention, the copolymer is prepared from PIP-g-MA (polyisoprene with grafted maleic anhydride) together with a Jeffamine polymer as described above, for example, Jeffamine M-2070.

Where the amphiphilic copolymer is a graft copolymer, each side chain of the graft polymer preferably has a molecular weight from about 800 to about 10,000. For example, each side chain may have a molecular weight between about 1000 to about 7500, between about 2500 to about 5000 or between about 6000 and about 9000.

Each side chain of the graft polymer preferably has a molecular weight from about 800 to about 10,000. For example, each side chain may have a molecular weight between about 1000 to about 7500, between about 2500 to about 5000 or between about 6000 and about 9000.

As used herein, the term maleic anhydride (MA) group encompasses maleic anhydride, maleic acid and salts thereof and maleic acid ester and salts thereof and mixtures thereof. For example, the copolymer may be prepared from a poly(ethylene oxide) backbone having maleic anhydride, acid or a salt or ester thereof grafts by reacting said backbone with an OH, NH₂, NHR, or SH functionalized hydrophobic side chain.

The maleic anhydride group coupling chemistry provides a convenient method for attaching the grafts to the copolymer backbone. However, the skilled person would appreciate that other functional groups would be equally effective in this regard.

By way of example, the reaction of another acyl group (e.g. a suitable carboxylic acid or acyl chloride) with a hydroxyl functionalised polymer will be suitable for forming an ester linkage between the graft and backbone. Various strategies for performing coupling reactions, or click chemistry, are also known in the art and may be utilised by functionalising the backbone with suitable groups, possibly in the presence of a suitable catalyst. For instance the reaction of an alkyl or aryl chloride group on the backbone with a hydroxyl group for instance (i.e. a Williamson coupling), or the reaction of a silicon hydride with an allyl group (a hydrosilyation reaction) could be utilised.

### Method of Synthesis

Typically, the copolymers used in certain embodiments of the invention are synthesised by dissolving the backbone and graft in an organic solvent (e.g. toluene) and maintaining the mixture at reflux for a period of time sufficient to ensure reaction.

In another preferred embodiment, the synthesis is carried out in the absence of solvent, i.e. using a no-solvent approach using any mixing apparatus capable of mixing the (still viscous) molten MPEO/PEO side chain and backbone together. Preferably, the reaction temperature is from about 160 to about 180° C.

The reactions are preferably carried out under an inert gas to avoid oxidation of the polymers and hydrolysis of the maleic acid/anhydride groups.

In one preferred embodiment, the synthesis involves reacting from about 1 to about 4, more preferably, about 3 equivalents of side chain precursors with respect to each acylating group. Further details of the synthesis are described in WO 2009/068569 which is hereby incorporated by reference.

Preferably, the acylating group is derived from a maleic anhydride unit (either pendant to the backbone or within the backbone). Suitable side chain precursors which are polyether amines are available commercially; a range of mono and difunctionalised amine polymers of ethylene oxide (EO) and propylene oxide (PO) are sold under the Jeffamine brand name by Huntsman. Reaction between the amine functionalized polymers with maleic anhydride derived units, for instance, can generate any of the following structures:

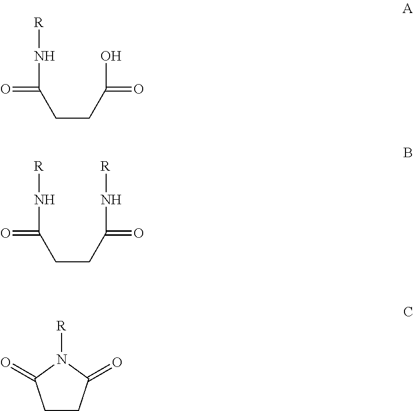

The structure denoted C may be formed by an intramolecular reaction of A, accompanied by the elimination of H₂O. This reaction is more likely to occur with the assistance of catalysis (e.g. by the addition of an acid). Both mono and difunctional amine polymers are suitable for use in the present invention. Depending on the reaction conditions, the use of hydrophilic difunctional amine side chain precursors can lead to a cross-linked or chain extended amphiphilic polymeric material. Alternatively, mono and difunctional side chain precursors may be combined to modify the properties of the resulting polymeric material as required. Jeffamine M-1000 and M-2070 are particularly preferred.

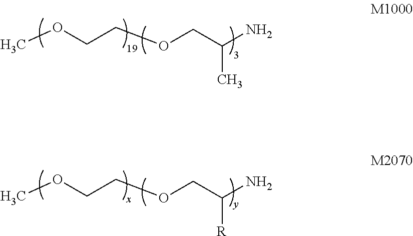

[wherein R=H for (EO), or CH₃ for (PO); x=6 (pure EO); y=35 (EO and PO).]

Jeffamine M-1000 is a monoamine polyether with a EO:PO ratio of 19:3 and a molecular weight of approximately 1000. M-2070 is a monoamine polyether with an EO:PO ratio of 31:10 and a molecular weight of approximately 2000. Due to their relatively high levels of ethylene oxide they are regarded as hydrophilic materials. Both M-1000 and M-2070 have been found to react efficiently with PIP-g-MA.

In another preferred embodiment, the amphiphilic copolymer is prepared from the reaction of backbone precursors with a monoester of maleic anhydride, for example, to form PIP-g-MaMme (polyisoprene-graft-monoacid monomethyl ester supplied by Kuraray Co. Ltd, sold as LIR-410) with the general formula shown below:

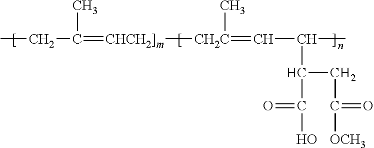

### PIP-g-MaMme

PIP-g-MaMme has a functionality (i.e. n) of approximately 10, an average molecular weight of about 25,000, and a glass transition temperature of −59° C. Each monomethyl ester may react with a single amine functionality.

As stated above, the properties of the amphiphilic copolymer depend not only on the character of the side chains grafted onto the carbon-carbon backbone, but also on the number of grafted side chains. In the present invention, one or more chain precursors react with each backbone precursor. More preferably, a plurality of side chain precursors react with each backbone precursor. The term “plurality” is defined herein as meaning more than one grafted side chain, i.e. more than one side chain precursor reacts with each backbone precursor.

In order to achieve the desired degree of hydrophilicity in the amphiphilic copolymer, it is preferred that the ratio of side chains to backbone repeat units in the resultant polymeric material is in the range of from about 1:350 to about 1:20, more preferably from about 1:150 to about 1:30. The side chains are preferably statistically distributed along the carbon-carbon backbone as the location of attachment of the side chain on the backbone will depend on the positions of suitable attachment locations in the backbone of the hydrocarbon polymer used in the manufacture.

When the side chains are linked to the polymer backbone via grafted maleic anhydride units, each maleic anhydride unit in the polymer backbone may be derivatised with either zero, one or two side chains.

In one preferred embodiment, the side chain precursors of general formula (I) or (II) comprise at least one nucleophilic group which is an amine. In the reaction to form an amphiphilic polymeric material, the nucleophilic groups react with pendant units on the polymer backbone which are acylating groups to form a polymeric material as defined above. Preferably, the pendant units are derived from maleic anhydride.

In one embodiment of the invention, each side chain precursor has two nucleophilic groups (for instance, X¹ is O or NR⁴) which may react with two acylating groups on different backbone precursor molecules, thereby forming a cross-linked structure. For example, a polyethylene oxide side chain is generally terminated with an alcohol at each end before derivatisation. Each alcohol may be grafted onto a maleic anhydride unit.

In some embodiments of the invention, where the acylating group is derived from maleic anhydride, only one side chain precursor reacts per maleic anhydride monomer. This leaves the unit derived from maleic anhydride with a free carboxylic acid group, which may be derivatised at a later stage in the method. This group may also be deprotonated to give an ionic pendant group in the polymeric material.

The reaction between the backbone precursors (for instance, PIP-g-MA) and the side chain precursors may be carried out in an organic solvent such as toluene. Typically, the reaction takes place at elevated temperatures, optionally in the presence of an activator for example, triethylamine. The yield may be increased by removal of the water from the reaction mixture by azeotropic distillation as toluene and water form azeotropic mixtures which boil at a lower temperature than any of the individual components.

The side chain precursor may also be reacted with a monoester derivative of PIP-g-MA, for example, the PIP-g-MaMme detailed above. The reaction of this monomethyl ester with the side chain precursor is typically carried out in an organic solvent such as toluene at elevated temperatures. Again, the yield of ester may be increased by removing water from the reaction mixture by azeotropic distillation.

Alternatively, the synthesis of the amphiphilic copolymer may be achieved by mixing the intended side chain precursors with the backbone precursors in the absence of solvent. This ‘no-solvent’ process eliminates the costs associated with purchasing and handling organic solvents and removing otherwise harmful materials from the polymer. It will be appreciated that this approach is also desirable in eliminating volatile organic compounds that may be harmful to the environment. Further details of the no-solvent synthesis may be found in WO 2009/050203, the contents of which are hereby incorporated by reference.

The side chain and backbone precursors may be either in the form of a solid or in fluid form (e.g. in the form of a liquid or a gel), provided that they can be mixed easily. More preferably, the side chain and backbone precursors are either in the form of a liquid or finely ground solid. In one embodiment of the invention, the side chain precursors are in liquid form and the backbone precursors are in the form of a finely ground solid. More preferably, both the side chain and backbone precursors are in the form of a liquid at the temperature at which the acylation reaction takes place.

In one preferred embodiment of the invention, the backbone precursors are mixed with the side chain precursors by dissolving the backbone precursors in molten side chain precursors.

It will be appreciated by those skilled in the art that the reaction process may be performed using any apparatus that is capable of providing sufficient mixing. This includes reactors or other any vessels where agitation is provided, for example, by an overhead stirrer or a magnetic stirrer. More preferably, mixing is achieved using an appropriate extruder, z-blade mixer, batch mixer, U trough mixer, RT mixer, compounder, internal mixer, Banbury type mixer, two roll mill, Brabender type mixer, a wide blade mixer (or hydrofoil blade mixer), horizontal (delta or helical) blade mixer, kneader-reactor, or a variation thereof, such as a double z-blade mixer or twin screw extruder.

Increasing the temperature of the reaction mixture generally results in the side chain precursors melting, which allows more efficient mixing, and in turn contributes to an increase in the rate of reaction. The temperature of the reaction is preferably from about 50° C. to about 300° C., more preferably from about 100 to about 250° C., even more preferably from about 120° C. to about 200° C., and more preferably still, from about 140° C. to about 180° C. Preferably, the mixing apparatus is flushed with an inert gas to prevent degradation of the polymeric materials. Alternatively, the reactor may be placed under vacuum in order to ensure that air is excluded. The reaction can also be catalysed by the addition of acid or base. Optionally, water may be added to the reactor at the end of the reaction to hydrolyse any unreacted acylating groups. Advantageously, the hydrolysis of unreacted acylating groups can increase the hydrophilicity, and thus water compatibility or solubility, of the materials.

Any remaining acylating groups are preferably converted into acid groups by the addition of water to the material, or by an ageing process. An ageing process typically involves leaving the material in atmospheric air to ensure hydrolysis of any residual maleic anhydride by atmospheric moisture. Alternatively, the remaining acylating groups are hydrolysed with the aid of a base catalyst, or by the addition of an alcohol (hydroxyl) or amine with or without base. By way of an example, any remaining maleic anhydride groups are preferably converted into diacid groups by addition of water to the material.

The reaction mixture, at the end of the reaction, normally comprises unreacted starting materials which may include free side chain precursor and backbone precursor. There may also be some residual catalyst, if this has been used in the reaction. The reaction generally produces no by-products. The amphiphilic polymeric material need not be purified from the reaction mixture, since it can be advantageous to have free side chain precursors in the final composition. The free side chain precursor may interact with the amphiphilic polymeric material, thereby improving its properties.

Any PIP-g-MA of appropriate molecular weight distribution and maleic anhydride content will be suitable for the synthesis of the polymeric material. Alternatively, carboxylated PIP-g-MA materials in which the maleic anhydride is ring-opened to form a diacid or mono-acid/mono-methyl ester are also be suitable.

Preferably, the backbone precursors of the polymeric materials are derived from polyisoprene to which maleic anhydride has been grafted. By way of illustration, the level of grafting of MA is typically around 1.0 mol % in the PIP-g-MA. In PIP-g-MaMme, the level was 2.7 mol % of the mono-acid mono-methyl ester of MA. The level of grafting depends on the degree of functionalisation of the polyisoprene, the chemical functionality on the maleic anhydride and the reactivity of the graft. Only potential site for grafting is present in PIP-g-MaMme whereas two are present in MA. For example, in RP11 (see below) the number of grafts per chain when a polyether amine like Jeffamine is used is generally between 1 and 14, whereas in RP10 (see below) it is between 1 and 10. An excess of graft may optionally be used.

In one preferred embodiment, preferably from about 1 to about 4, more preferably from about 2 to about 3 equivalents of side chain precursors with respect to each maleic anhydride group are reacted. Reaction efficiency is greater with the polyether amines used to synthesize RP7 as opposed to the alcohol functionalised polyether used to make RP6. In addition the molecular weight of the graft can have an effect on the degree of grafting with the 5000 molecular weight MPEO used to make RP5 reacting less efficiently than lower molecular weight graft like 1000 molecular weight MPEO used in RP1. A range of useful graft are available commercially; for instance a range of mono and difunctionalised amine polymers of ethylene oxide (EO) and propylene oxide (PO) are sold under the Jeffamine brand name by Huntsman. PEO and PEO of various molecular weights are available from Clariant and Geo Specialities.

When the backbone precursor of the amphiphilic polymeric material is a copolymer of maleic anhydride together with an ethylenically-unsaturated monomer, side chain precursors are typically terminated by an alcohol or amine nucleophilic group at one end and an alkyloxy group at the other. MeO-PEO-OH (MPEO) is an example of a preferred side chain precursor. In the method of formation of the polymeric material such side chains react with the maleic anhydride derived units via alcoholysis of the anhydride to give a carboxylic ester and carboxylic acid.

The reaction of maleic anhydride with an alcohol is an alcoholysis reaction which results in the formation of an ester and a carboxylic acid. The reaction is also known as esterification. The reaction is relatively fast and requires no catalyst, although acid or base catalysts may be used.

The net reaction may be represented as shown below. Pₓ and P_{Y} represent the remainder of the copolymer/terpolymer and ROH is a representative side chain precursor.

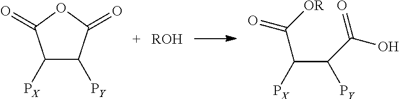

In one preferred embodiment, two side chains precursors represented by ROH may react at the same maleic anhydride monomer to give a compound of general formula

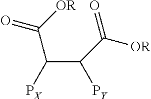

Alternatively, only one side chain precursor reacts per maleic anhydride monomer. This leaves the unit derived from maleic anhydride with a free carboxylic acid group, which may be derivatised at a later stage in the method. This group may also be deprotonated to give an ionic backbone in the polymeric material.

In one preferred embodiment, the side chain precursors may have hydroxyl or amine groups at each of their termini and each terminus reacts with a unit derived from maleic anhydride in different backbones to form a cross-linked polymeric material.

After reaction of the side chain precursors with a backbone precursor which comprises units derived from maleic anhydride in the backbone, any unreacted units derived from maleic anhydride in the backbone may be ring-opened. This may be performed by hydrolysis, or using a base. The resulting product may be ionisable. This further reaction step has particular utility when there is a large proportion of maleic anhydride in the backbone, for instance in an alternating copolymer.

In one preferred aspect of the invention the backbone precursors comprise pendant units of general formula (IV),

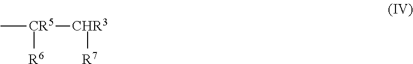

wherein R³ and R⁵ are each independently H or alkyl, and R⁶ and R⁷ are each independently H or an acyl group, provided that at least one of R⁶ and R⁷ is an acyl group, or R⁶ and R⁷ are linked to form, together with the carbon atoms to which they are attached, a group of formula (V),

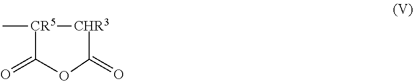

with a side chain precursor of formula (VI)

HX¹—Y—X²P (VI)

wherein:
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group;
and in the method, the group HX¹ in the compound of formula (VI) reacts with the units of general formula (IV) or (V) to give the amphiphilic polymeric material wherein the side chains are of general formula (I)

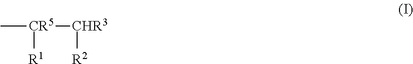

wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II)

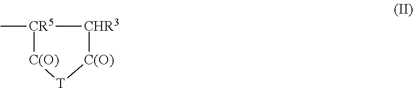

wherein:
R³ and R⁵ are each independently H or alkyl;

### W is O or NR⁴;

Q is a group of formula —X¹—Y—X²P;
T is a group of formula —N—Y—X²—P;
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

In one preferred aspect of the invention the backbone precursors are part of the backbone itself (for example when maleic anhydride is part of the backbone), i.e.,

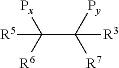

wherein each substituent has the definition set forth above.

The side chains thus have the general formula of R¹ and R² as defined above.

The side chains in the amphiphilic polymeric material thus comprise a unit derived from the acyl group of the backbone precursors.

The preferred substituents are the same as those given above for the preferred side chains in the polymeric material.

The following copolymers were prepared according to the methodology set forth in the examples.

TABLE 1
Amphiphilic Graft Copolymers

| | | | | | Amount of |
|---|---|---|---|---|---|
| | | Amount of | Amount of | Amount of | Jeffamine |
| | | MPEO 1K | MPEO 2K | MPEO 5K | M-2070 |
| Poly- | | (equiv- | (equiv- | (equiv- | (equiv- |
| mer | Backbone | alents)¹ | alents)¹ | alents)¹ | alents)¹ |
| RP1 | PIB-alt-MA 6K | 0.1 | 0.0 | 0.0 | 0.0 |
| RP2 | PIB-alt-MA 60K | 0.0 | 1.0 | 0.0 | 0.0 |
| RP3 | PIB-alt-MA 6K | 0.0 | 0.5 | 0.0 | 0.5 |
| RP4 | C18-alt-MA 30K | 0.0 | 0.0 | 0.3 | 0.0 |
| RP5 | C18-alt-MA 30K | 0.0 | 0.0 | 0.5 | 0.0 |
| RP6 | C18-alt-MA 30K | 0.0 | 1.0 | 0.0 | 0.0 |
| RP7 | PS-alt-MA 2K | 0.0 | 0.0 | 0.0 | 1.0 |
| RP8 | PBD-g-MA | 0.0 | 0.0 | 0.0 | 2.0 |
| RP9 | PBD-g-MA | 0.0 | 2.0 | 0.0 | 0.0 |
| RP10 | PIP-g- MaMme | 0.0 | 0.0 | 0.0 | 1.0 |
| RP11 | PIP-g- MA | 0.0 | 0.0 | 0.0 | 1.0 |

PIP = polyisoprene;
PBD = polybutadiene;
g = graft;
MA = maleic anhydride;
MaMme = monoacid monomethyl ester;
PIB-alt-MA = Poly(isobutylene-alt-maleic anhydride);
PS-alt-MA = Poly(styrene-alt-maleic anhydride);
C18-alt-MA = Poly(maleic anhydride-alt-1-octadecene);
MPEO = methoxy poly(ethylene oxide);
K = 1000 molecular weight units.
¹By number of equivalents of graft (e.g MPEO, PEO or Jeffamine) in Table 1 above, it should be understood that the ratio of graft to each unit of MA in the backbone is indicated. For instance in the case of RP6, 1.0 equivalents of MPEO 2K were added relative to each unit of MA. In the case of RP4, 0.3 equivalents of MPEO 5K were added to each MA unit and thus a maximum of 30% of the MA will have reacted with graft. The PIP-g-MA has an average of 2-5 MA units per chain, or typically less than 2% by weight, are available for reaction with grafts. The PS-alt-MA backbone is an alternating copolymer of styrene and MA, and thus by contrast has between approximately 45 and 50 weight percent of MA. Thus, more MPEO is actually added to RP7 than RP11 and the resulting polymer would be expected to have a higher HLB than RP11, in other words be more hydrophilic. As previously discussed each MA may potentially act as the coupling point for two grafts, MaMme may act as the coupling point for a single graft.

In one highly preferred embodiment of the invention, the amphiphilic copolymer is RP1, RP2, RP3, RP4, RP5, RP6, RP7, RP8, RP9, RP10, RP11, or a mixture thereof. In one particularly preferred embodiment, the amphiphilic copolymer is RP3, RP7, RP11 or a mixture thereof.

### Latex Preparation

The latex compositions of the invention comprise a dispersion of an amphiphilic copolymer as described above in an aqueous solution, preferably water, more preferably deionised water

Preferably, the ratio of amphiphilic copolymer to aqueous solution is 0.5:99.5 to 70:30, more preferably 1:99 to 60:40, even more preferably 2:98 to 55:45 even more preferably 5:95 to 50:50.

In one preferred embodiment of the invention, the latex composition further comprises one or more of the following: a surfactant, an organic solvent, a defoaming or antifoaming agent, an antimicrobial agent (preservative), biocide, an antioxidant, a buffering agent, a neutralising agent, a plasticizer and a stabilizer.

Within the most strict technical sense of the terms, an antifoaming agent is used to prevent the formation of foam and a defoaming agent assists in the destruction of pre-existing foam. The two terms are however often used interchangeably in the general practice of the art and unless otherwise noted are used interchangeably here. Defoaming agents suitable for use in the latex will be familiar to the skilled person in the art and may initially be added either to the aqueous phase or the polymer. Defoaming agents may be single substances or may be mixtures consisting of two or more different substances, including for instance hydrophobic solids, silicone based substances, fatty substances. Preferably any solid present in the antifoam mixtures is of a small particle size to increase efficacy, ease formulation and reduce the solid's visibility in the product.

In one highly preferred embodiment the defoaming agent is BYK-022 (a VOC-free defoamer consisting of polysiloxanes and hydrophobic solids in polyglycol, manufactured by Byk). In another preferred embodiment the defoaming agent is BYK-1740 (hydrophobic particles and foam-destroying fat derivatives, manufactured by Byk). In another highly preferred embodiment the defoaming agent is a fatty acid ester.

In a particularly preferred embodiment the antifoam may also possess some surfactancy, such as for instance Synperonic NCA 810 (alcohol ethoxylate, Croda) and Synperonic LF 26 (ethylene and propylene oxide alkoxylate of a fully saturated alcohol, Croda). Such surfactants are sufficiently hydrophobic to prevent them having sufficient solubility in water to form a homogenous solution. This low solubility is necessary in order to ensure that they will tend to be present at interfaces to counteract foaming. They can also be used as a cosurfactant to help disperse or solubilise the polymer and may assist products formulated with the latex to wet substrates. Other defoaming agents are also suitable for use in the present invention.

Preferably, the defoaming agent is present in the aqueous phase in an amount of up to 10% by weight of the latex composition, more preferably, from about 0.1% to about 10%, even more preferably, from about 1% to about 8%, more preferably, from about 1% to about 5%, or about 1% to about 4% by weight.

Alternatively, the defoaming agent is present in the oil phase, and is preferably present in an amount of up to 10% by weight, more preferably, from about 0.1% to about 10%, even more preferably, from about 1% to about 8%, more preferably, from about 1% to about 5%, or about 1% to about 4% by weight.

Surfactants may be used in the manufacture of a polymer latex to stabilise the colloidal dispersion of polymer in water. In a preferred embodiment, one or more surfactants are added to either the aqueous or oil phase or both. In the case of the aqueous phase, the surfactant is typically dissolved in water prior to use. When added to the oil phase, the surfactant may be dissolved in any solvent present or may for instance be dissolved or dispersed into the molten polymer.

Suitable surfactants include non-ionic, anionic or cationic or zwitteronic (amphoteric) structures. HSC formulations typically contain surfactants to clean surfaces the end user treats them with. To avoid incompatibles with the final HSC formulation the identity of the surfactant used to stabilise the system should be considered. For instance if an anionic surfactant is used in the HSC formulation it is preferable to avoid the use of a cationic surfactant in the manufacture of the latex.

Suitable anionic surfactants include, but are not limited to, alkyl and/or aryl sulfates, sulfonates, phosphates, or carboxylates such as sodium lauryl sulfate, sodium salt of alkylaryl polyether sulfates, linear alcohol ethoxylate phosphates, alkylphenol ethoxylate phosphates, and mixtures thereof.

Suitable non-ionic surfactants include oxyalkylated fatty amines, fatty acid amides and/or monoalkylphenols such as oxyethylated lauryl alcohol, oxyethylated oleyl alcohol, oxyethylated stearyl alcohol, oxyethylated p-iso-octylphenol, oxyethylated p-n-nonylphenol, oxyethylated p-n-dodecylphenol. Particularly preferred oxyalkylated surfactants include fatty alcohol ethoxylates such as those sold by Croda under the Synperonic® name and the like. These fatty alcohol ethoxylates include for example Synperonic 91/8 consisting of a C9-11 fatty alcohol with 8 moles of EO, Synperonic 91/6 consisting of a C9-11 fatty alcohol with 6 moles of EO, Synperonic 13/8 consisting of a C13 fatty alcohol with 8 moles of EO, Synperonic 13/9 consisting of a C13 fatty alcohol with 9 moles of EO and Synperonic 13/10 consisting of a C13 fatty alcohol with 10 moles of EO. In one preferred embodiment the surfactant is a low foaming surfactant such as Synperonic NCA 830 and 850 (alcohol ethoxylates) or LF 28, 290 and 30 (ethylene and propylene oxide alkoxylates of fully saturated alcohols) manufactured by Croda. Other suitable surfactants include fluorocarbon-based materials.

In one highly preferred embodiment the latex composition comprises a surfactant in the aqueous phase, wherein the surfactant is selected from DOSS (dioctyl sodium sulfosuccinate), SDBS (sodium dodecylbenzene sulfonate) and a fatty alcohol ethoxylate (e.g. Synperonic 91/8).

Preferably, the aqueous phase comprises from 0 to about 30% by weight of the surfactant, more preferably from 0 to about 25%, more preferably from 0 to about 10%, or 0 to about 5% by weight of the latex composition. In another preferred embodiment, the aqueous phase comprises from 1 to about 30% by weight of the surfactant, more preferably from 1 to about 25%, more preferably from 1 to about 10%, or 1 to about 5% by weight of the latex composition.

In one highly preferred embodiment the latex composition comprises a surfactant in the oil phase, wherein the surfactant is selected from DOSS, SDBS and Neodol 25-7.

Preferably, the oil phase comprises from 0 to about 75% by weight of the surfactant, more preferably from 0 to about 70%, or 0 to about 50%, more preferably from 0 to about 40% by weight of the latex composition. In another preferred embodiment, the oil phase comprises from 1 to about 75% by weight of the surfactant, more preferably from 1 to about 70%, or 1 to about 50%, more preferably from 1 to about 40% by weight of the latex composition.

Various other additives may also optionally be added to the latex of the invention. The latex may for instance be preserved by the addition of a suitable chemical agent to reduce the growth of microbial contaminants (for instance an alkyl paraben, such as methyl, or ethyl paraben or an aldehyde such as glutyraldehye). An antioxidant such as BHT may also be added if oxidative stability is a concern. The addition of surfactants to stabilise the latex can result in the entrainment of air and subsequent foaming which can interfere with efficient manufacture of the latex. Optionally an antifoaming agent may be added to the aqueous and/or oil phase prior to latex manufacture to suppress the generation of foam. A wetting agent such as EnviroGem 360 may also be added to change the behaviour of the product on surfaces and at other interfaces. An agent may be added to increase the freeze thaw stability of the resulting latex. Buffering agents, neutralizing agents, plasticizers and polymeric stabilizers may also be added.

A further aspect of the invention relates to a process for preparing a latex composition as described above.

In one preferred embodiment, the process comprises the addition of the amphiphilic copolymer to an aqueous solution, optionally in the presence of one or more surfactants.

In an alternative preferred embodiment, the process comprises the addition of an aqueous solution to the amphiphilic copolymer, optionally in the presence of one or more surfactants.

As is known in the prior art, it is possible to manufacture polymers directly in a latex format. For instance, stable latexes may be manufactured by emulsion polymerisation of suitable monomers in situ. Most typically, however, the polymers of use in the present invention are initially manufactured in the absence of water. The user is therefore tasked with the requirement of converting the neat polymer into an aqueous dispersion.

There are a number of different methods known in the prior art for making dispersions from polymers which may be utilised for the manufacture of latexes of the polymers used in this invention. In order for a dispersion to be stable it is necessary to control the particle size of the dispersed oil or polymer phase in order to ensure that the polymer phase does not settle out of suspension. To achieve this it is typically necessary to carefully control the method of addition of an oil (i.e. non-aqueous) phase to water (or visa-versa) in the presence of chemical dispersants and/or surfactants whilst applying sufficient agitation/mechanical force to break up the oil phase. This oil phase may for instance comprise a polymer in a fluid (i.e. molten) state or may comprise a solution of the polymer in a suitable solvent. The polymer may be self-dispersing, meaning it has pendant anionic/non-ionic/cationic groups which facilitate its emulsification and stabilisation in the water phase. Alternatively, if the polymer is not readily dispersible, then surfactants may be required to disperse the polymer; these may be mixed into the oil phase prior to dispersion or may be present in the water phase prior to dispersion.

Generally, methods for creating latexes may be divided into two processes. In the first of these, often referred to as the ‘direct method’, the oil phase is added in a controlled manner to the stirred aqueous phase resulting in the formation of dispersed polymer particles in the water.

An alternative method for manufacturing the polymer is the inversion method, in which the aqueous phase is added to the oil phase. Initially the product of this process is the forced formation of an emulsion of water in the oil phase, However, upon continued addition of the aqueous phase, the system inverts to a dispersion of the oil phase in water and formation of the latex.

In one preferred embodiment of the invention, the oil phase is a solution of the polymer in an organic liquid in which the polymer is soluble at ambient or elevated temperature. Particularly preferred solvents include tetrahydrofuran, methyl ethyl ketone, chloroform, acetone and alcohols dependent upon the solubility of the polymer. After formation of the latex, the solvent may be removed by any purification technique that does not destabilise the resulting latex. In a particularly preferred embodiment the solvent has a boiling point below that of water allowing it to be readily removed by distillation.

In one highly preferred embodiment the latex comprises a solvent in the oil phase, wherein the solvent is selected from cyclohexane, MEK, CHCl₃ and acetone.

Preferably, the solvent is present in an amount of up to 75% by weight, more preferably, from about 1 to about 70% by weight, or about 1% to about 50% by weight of the latex composition.

The latex compositions described herein have applications in the field of hard surface cleaning (HSC) formulations. Typically, the latex compositions are used as additives in HSC formulations. Adding the amphiphilic copolymer to the HSC formulation in the form of a latex makes it easier to incorporate. Such a format is easier to formulate in that dependent upon the formulation, it allows the polymer to be delivered in a particulate format that it is sufficiently fine to enable easy spreading by the consumer. Even more preferably, the high surface area of the polymer in the latex allows it to dissolve into an HSC formulation with the aid of the surfactants present in the cleaning product.

A number of latexes of polymers suitable for use in the HSCs were manufactured and are described in the table below in order to illustrate the invention.

TABLE 2
Latexes of polymer RP11

| | | Surfactant in | | Solvent in | Surfactant in | Defoamer in |
|---|---|---|---|---|---|---|
| Latex | Addition | Aqueous phase | Defoamer | Oil phase | oil phase | oil phase |
| RL1 | Direct | 1 wt % DOSS | 2.5 wt % | 70 wt % | None | None |
| | | | BYK-022 | Cyclohexane | | |
| RL2 | Direct | 1 wt % DOSS | 2.5 wt % | 70 wt % | None | None |
| | | | BYK-022 | CHCl3 | | |
| RL3 | Direct | 1 wt % DOSS | 2.5 wt % | 70 wt % MEK | None | None |
| | | | BYK-022 | | | |
| RL4 | Direct | 1 wt % DOSS | 2.5 wt % | 70 wt % | None | None |
| | | | BYK-022 | Acetone | | |
| RL5 | Direct | 1 wt % | 3.5 wt % | 70w % CHCl3 | None | None |
| | | | BYK-022 | | | |
| RL6 | Direct | 1 wt % DOSS | 1 wt % | None | 10 wt % DOSS | 5 wt % |
| | | | BYK-022 | | | |
| RL7 | Direct | 1 wt % DOSS | 1.5 wt % | None | 33 wt % | None |
| | | | BYK-022 | | Neodol 91-8 | |
| RL8 | Direct | 1 wt % DOSS | 1 wt % | None | 10 wt % DOSS | 5 wt % |
| | | | BYK-022 | | | |
| RL9 | Inversion | 1 wt % DOSS | 2 × 3.5 wt % | None | 8 wt % SDBS | None |
| | | | BYK-022 | | | |
| RL10 | Inversion | None | None | None | 70 wt % SDBS | None |
| RL11 | Inversion | None | None | None | 33 wt % | None |
| | | | | | Neodol 25-7 | |
| RL12 | Inversion | 1 wt % SDBS | None | None | 33 wt % | None |
| | | | | | Neodol 25-7 | |
| RL13 | Direct | 25 wt % SDBS | None | None | None | None |
| RL14 | Inversion | 5 wt % DOSS | None | None | None | None |
| RL15 | Inversion | 10 wt % | None | None | None | None |
| | | Synperonic | | | | |
| | | 91/8 | | | | |
| RL16 | Inversion | 5 wt % | None | None | None | None |
| | | Synperonic | | | | |
| | | 91/8 | | | | |
| RL17 | Inversion | 5 wt % DOSS | 1 wt % NCA | None | None | None |
| | | | 810 | | | |
| RL18 | Direct | 5 wt % DOSS | 2.5 wt % | None | None | None |
| | | | BYK-022 | | | |

It will be appreciated that these examples are not intended to limit the scope of the invention and that a wide range of combinations of ingredients, including polymers, surfactants, solvents, antifoams and other ingredients as previously described may be used in the context of the present invention. Similar latexes may be formed with amphiphilic polymers RP1-10 as described in Table 1.

### Hard Surface Cleaners Containing the Latex Additive

The latex compositions described herein may be used as additives in hard surface cleaning products that take a variety of formats including sprays, cleaning fluids and bucket-dilutable cleaners. The latex compositions of the invention may be used in industrial and institutional cleaning products. Typically, the latex compositions of the invention are present in the HSC formulation in an amount of from about 0.5 to 50 weight %, more preferably from about 2.5 to 25 weight %. Hard surface cleaners [e.g. for industrial and institutional (I&I) use] may be supplied to the end user in a variety of different formats including those that are applied manually and those that are applied with the aid of a machine. For instance the product may be supplied in a concentrated format designed to be used neat. In this case the product may take the form of a pump action/trigger spray or aerosol product which is applied directly to the hard surface and then removed by the end user (“a spray and wipe process”). Alternatively, the product may be applied from the bottle in the form of a liquid or a cream. In another embodiment the polymer is in the form of a concentrate that is diluted prior to use. By way of an example, such a product might be mixed in to a bucket of water by the end user and applied to flooring using a mop (“a bucket dilutable cleaner”).

In one preferred embodiment, the formulation is supplied as a concentrate that is added to apparatus designed to clean hard surfaces. For instance the apparatus combines the concentrate with a reservoir of water which is then applied mechanically to flooring. Such devices are available commercially by a range of different manufacturers see for instance the Taski® range of cleaning apparatus manufactured by Sealed Air.

HSC formulations containing latex compositions according to the invention typically contain between about 0.1 and about 15 weight %, more preferably about 0.25 to about 10 weight % of the amphiphilic copolymers as a total of the overall HSC formulation. Addition of the amphiphilic copolymers to the formulations may be used to increase the gloss of the surfaces the product cleans. Without being bound by theory, the polymer is believed to be deposited from the cleaning product in the form of a high gloss polymeric film.

In the case of most formulations such as multi-surface cleaners, typically the majority of the formulation is water. Formulations designed to clean specific surfaces (e.g. glass) may optionally contain high quantities of another volatile material such as alcohols (e.g. ethanol or isopropanol) or acetic acid.

In the case of more hydrophilic graft copolymers, the amphiphilic graft copolymers can be formulated directly in water. Whilst more hydrophilic polymers may be easier to formulate, more hydrophobic polymers have a greater tendency to deposit on the surfaces being cleaned allowing them to enhance gloss. More typically therefore the polymer is more hydrophobic and is formulated into an aqueous solution containing any surfactants used in the formulation. In this case the polymer may be incorporated using an overhead stirrer or alternatively the mixture may be agitated by means of e.g. a drum mixer. In a preferred embodiment the polymer is added in the form of a latex using normal mixing methods. Typically the other ingredients are added using standard mixing techniques.

The hard surface cleaning formulations containing latex compositions according to the invention may also include various adjuvants. Examples of such adjuvants include fragrances, preservatives, dyes, corrosion inhibitors, antioxidants and the like.

The hard surface cleaning formulations containing latex compositions according to the invention preferably contain up to about 15 weight % of one or more surfactants designed to clean contaminants such as oil and grease from the hard surfaces to be cleaned. These surfactants may be any suitable anionic, cationic, non-ionic or amphoteric surfactant; most typically they are anionic (e.g. alkylbenzenesulfonates) or non-ionic surfactants (e.g. fatty alcohol ethoxylates).

Preferably the hard surface cleaning formulations contain a least one surfactant that is able to wet the surface of the substrate being cleaned to increase the efficiency of the deposition of the polymers on the surfaces being cleaned.

By way of example, suitable anionic surfactants include, but are not limited to, those listed hereinabove.

By way of example, suitable non-ionic surfactants include, but are not limited to, those listed hereinabove.

By way of example, suitable cationic surfactants include, but are not limited to, benzalkonium chloride, benzethonium chloride, cetrimonium bromide or cetrimonium chloride.

By way of example, suitable amphoteric surfactants include, but are not limited to, (3-[(3-cholamidopropyl)dimethylammonio]-1-propanesulfonate).

The amphiphilic graft copolymer may also act as an anti-redeposition agent preventing dirt that has been solubilised by the surfactants depositing again. Other conventional anti-redeposition agents may also be added to the formulations of the invention.

In one preferred embodiment, the hard surface cleaning formulation contains a fragrance (e.g. oil or perfume) up to about 5.0 weight % in composition. In this instance the amphiphilic graft copolymer may also provide retention of the fragrance, and most preferably the backbone is a polymer formed by the polymerisation of a diene monomer like butadiene or isoprene. Particularly preferred examples are polymers with backbones of isoprene or butadiene grafted with maleic anhydride and functionalised with either a hydrophilic polyether like MPEG/MPEO or a Jeffamine, for instance polymer RP11.

The I&I cleaning formulation of the invention may optionally include colouring agents such as colours or dyes at levels up to about 0.5 weight %, preservatives and antioxidants up to a level of about 2 weight %, such as formaldehyde, glutaraldehyde, 5-bromo-5-nitro-1,3-dioxane (bronidox), 2-methylisothiazol-3(2H)-one (methyliso-thiazolinone) and/or 2,6-bis(1,1-dimethylethyl)-4-methylphenol (BHT). The cleaning formulations may also comprise a bactericide or fungicide to clean the hard surface being treated of microorganisms or to provide long lasting protection from the growth of microorganisms. An opacifier (up to about 4 weight %) may optionally be added to the formulations if an opaque formulation is required.

The I&I cleaning formulations may have a pH around neutral (pH7) or may optionally be adjusted either to ensure compatibility with the HSC or to change their cleaning performance. For instance an acidic formulation may have utility in cleaning limescale, whereas a basic one may assist removing oily contaminants. The pH of the formulations may also be adjusted by the addition of a suitable acid (e.g. acetic, citric, sulphuric or hydrochloric) or base (e.g. sodium or potassium hydroxide). In the instance of formulations intended to clean outside surfaces stronger acids such as phosphoric and hydrofluoric may optionally be used. The formulations may optionally further comprise up to about 1 weight % of a bleaching agent (e.g. oxygen or chlorine based) to clean surfaces. Formulations designed for cleaning metallic hard surfaces may also contain chelating agents (e.g. thiourea) and/or abrasives (e.g. inorganic materials).

The present invention is further described by way of the following non-limiting examples, and with reference to the following figures, wherein:

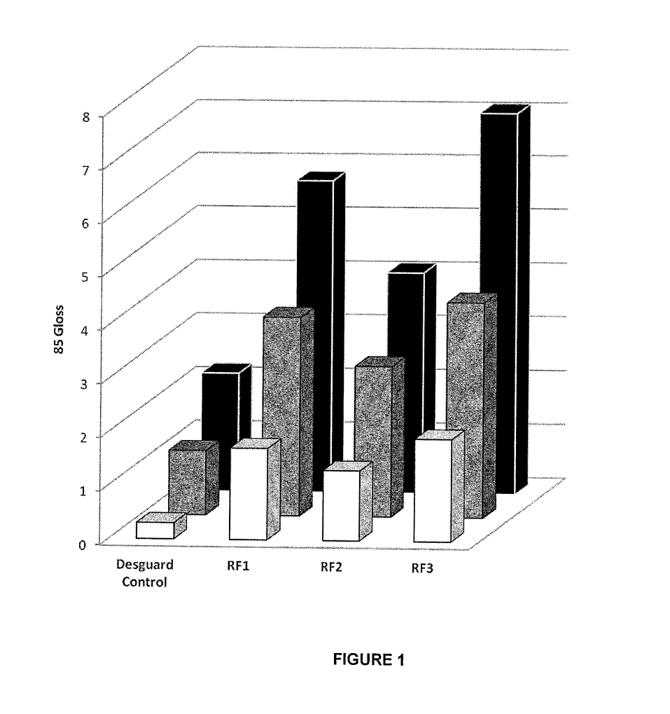

FIG. 1 shows a comparison of Gloss Uplift (ΔGloss at 85°) recorded with HSC Formulation with and without polymers on vinyl tiles after 1 application (white bars), 2 applications (grey bars) and 3 applications (black bars).

### EXAMPLES

### Materials Used in Polymer, Latex and Formulation Manufacture

The following materials were used in the manufacture of the examples used to illustrate the latex additive of the invention.

Dimethylformamide (DMF), toluene and tetrahydrofuran (THF) were obtained from Sigma Aldrich in anhydrous or analytical grades and used as received. Acetone, Cyclohexane, chloroform (CHCl₃), diethyl ether, hexane, methyl ethyl ketone, sodium dodecylbenzene sulfonate (SDBS) and dioctyl sodium sulfosuccinate (DOSS) were obtained from Sigma Aldrich in technical grade and used as received.

Poly(isobutylene-alt-maleic anhydride) (PIB-alt-MA) of molecular weight 6000 and 60 000 was obtained either from Sigma Aldrich or from Kuraray where the polymers are sold under the names ISOBAM-600 and ISOBAM-04. Poly(maleic anhydride-alt-1-octadecene) of molecular weight 20,000-25,000 was obtained either from Sigma Aldrich or from Chevron Phillips where it is sold under the name PA-18 LV. Poly(styrene-alt-maleic anhydride) (PS-alt-MA, SMA 1000) of molecular weight 2000 was obtained from Sartomer.

Lithene N4-9000-10MA (Poly(butadiene-graft-maleic anhydride of Mn 9500M and having approximately 9.2 MA units per polymer chain) was obtained from Synthomer. Poly(isoprene-graft-maleic anhydride) (PIP-g-MA, LIR-403) and poly(isoprene-graft-maleic monoacid monoester) (PIP-g-MaMme, LIR-410) were obtained from Kuraray. Alternatively PIP-g-MA (sometimes referred to as known as MAGPI) was obtained by the reaction of maleic anhydride and polyisoprene as described in WO 2009/068569 A1.

Methoxy poly(ethylene oxide) [also know as poly(ethylene glycol)methyl ether] of molecular weights 1000 Da (Polyglykol M1000), 2000 (Polyglykol M2000), and 5000 (Polyglykol M5000) were obtained from Clariant. Jeffamine M-2070 (amine functionalised copolymer of ethylene oxide and propylene oxide) was obtained from Huntsman

Neodol 91-8 (C9-11 alcohol ethoxylated with 8 units of ethylene oxide, Shell Chemicals, also sold as Dobanol 91-8), Neodol 25-7 (C12-15 alcohol ethoxylated with 7 units of ethylene oxide, Shell Chemicals, also sold as Dobanol 25-7), Synperonic 91/8 (C9-11 alcohol ethoxylated with 8 units of ethylene oxide, Croda), BYK-022 (a VOC-free defoamer consisting of polysiloxanes and hydrophobic solids in polyglycol, Byk), Synperonic NCA 810 (a defoamer/low foaming alcohol ethoxylate surfactant sold by Croda) and EnviroGem 360 (Air Products, stated by the manufacturer to be the reaction products of 1-octanol with epichlorohydrin and 2-mercaptoethanol) were used as received.

Hard surface cleaning product Desguard 20 (Ecolab) was obtained commercially from distributors and used as described in the examples.

### Amphiphilic Graft Co-Polymer Synthesis

### Example 1

### Reaction of Poly(isobutylene-alt-maleic anhydride 6K) with Methoxy Poly(ethylene oxide 1K) (Preparation of RP1)

Poly(isobutylene-alt-maleic anhydride) (Mₙ: 6000 g mol⁻¹, 110 g) and methoxy poly(ethylene oxide) (Mₙ: 1000 g mol⁻¹, 71 g) were dissolved in a mixture of DMF (200 mL) and toluene (200 mL) in a reaction flask. The flask was heated at reflux temperature under nitrogen gas for 72 h, any water present being removed from the reaction by means of azeotropic distillation and collection into a Dean-Stark apparatus. The resulting polymer solution was cooled and precipitated into diethyl ether, the polymer recovered using filtration, and dried to remove traces of solvent. The product was studied using GPC and FTIR.

### Example 2

### Reaction of Poly(isobutylene-alt-maleic anhydride 60K) with Methoxy Poly(ethylene oxide 2K) (Preparation of RP2)

Polymer RP2 was synthesized in the same manner as polymer RP1 using poly(isobutylene-alt-maleic anhydride) (Mₙ: 60,000 g mol⁻¹, 7.7 g) and methoxy poly(ethylene oxide) (Mₙ: 2000 g mol⁻¹, 100 g) as the graft. Reaction was allowed to continue for a total of 72 h. The product was studied using GPC and FTIR.

### Example 3

### Reaction of Poly(isobutylene-alt-maleic anhydride 6K) with Methoxy poly(ethylene oxide 2K) and Jeffamine M-2070 Polyether Amine (Preparation of RP3)

Poly(isobutylene-alt-maleic anhydride) (Mₙ: 6000 g mol⁻¹, 38.5 g), methoxy poly(ethylene oxide) (Mₙ: 2000 g mol⁻¹, 250 g) were dissolved in a mixture of DMF (50 mL) and toluene (50 mL) in a reaction flask. The flask was heated at 160° C. under nitrogen gas for 48 h, any water present being removed from the reaction by means of azeotropic distillation and collection into a Dean-Stark apparatus. Jeffamine M-2070 polyether amine (Mₙ: 2000 g mol⁻¹, 250 g) was then added to the reaction and the mixture allowed to react for another 24 h. The resulting polymer solution was allowed to cool to r.t. and precipitated into diethyl ether, the polymer recovered using filtration, and dried to remove traces of solvent. The product was studied using GPC and FTIR.

### Example 4

### Reaction of Poly(isobutylene-alt-maleic anhydride 6K) with Methoxy Poly(ethylene oxide 2K) and Jeffamine M-2070 Polyether Amine (Preparation of RP3)

Poly(isobutylene-alt-maleic anhydride) (Mₙ: 6000 g mol⁻¹, 7.7 g) and methoxy poly(ethylene oxide) (Mₙ: 2000 g mol⁻¹, 50 g) were placed in a reaction flask and heated to 160° C. under nitrogen gas. When the vessel reached elevated temperature and the MPEO had melted agitation of the mixture commenced to obtain intimate mixing and therefore reaction of the two. After 48 h reaction, Jeffamine M-2070 polyether amine (Mₙ: 2000 g mol⁻¹, 50 g) was then added to the mixture. After a further 24 h the vessel was allowed to cool and the resulting polymer recovered. The product was studied using GPC and FTIR.

### Example 5

### Reaction of Poly(maleic anhydride-alt-1-octadecene, ˜30K) with

Methoxy Poly(ethylene oxide 5K) (Preparation of RP4) Poly(maleic anhydride-alt-1-octadecene) (Mₙ: 30,000 g mol⁻¹, 35 g), methoxy poly(ethylene oxide) (Mₙ: 5000 g mol⁻¹, 150 g) were dissolved in toluene (400 mL) in a reaction flask. The flask was heated at reflux temperature under nitrogen gas for 72 h, any water present being removed from the reaction by means of azeotropic distillation and collection into a Dean-Stark apparatus. The resulting polymer solution was cooled and precipitated into hexane, the polymer recovered using filtration, and dried to remove traces of solvent. The product was studied using GPC and FTIR.

### Example 6

### Reaction of Poly(maleic anhydride-alt-1-octadecene, ˜30K) with Methoxy Poly(ethylene oxide 5K) (Preparation of RP5)

Polymer RP5 was synthesized in the same manner as polymer RP4 using poly(maleic anhydride-alt-1-octadecene) (Mₙ: 30,000 g mol⁻¹, 25 g), methoxy poly(ethylene oxide) (Mₙ: 5000 g mol⁻¹, 179 g) as the graft. Reaction was allowed to continue for a total of 72 h. The product was studied using GPC and FTIR.

### Example 7

### Reaction of Poly(maleic anhydride-alt-1-octadecene, ˜30K) with Methoxy Poly(ethylene oxide 2K) (Preparation of RP6)

Polymer RP6 was synthesized in the same manner as polymer RP4 using Poly(maleic anhydride-alt-1-octadecene) (Mₙ: 30,000 g mol⁻¹, 50 g), methoxy poly(ethylene oxide) (Mₙ: 2000 g mol⁻¹′, 285 g) as the graft. Reaction was allowed to continue for a total of 72 h. The product was studied using GPC and FTIR.

### Example 8

### Reaction of Poly(styrene-alt-maleic anhydride, ˜2K) with Jeffamine M-2070 Polyether Amine (Preparation of RP7)

Poly(styrene-alt-maleic anhydride) (SMA 1000, Mₙ: 2000 g mol⁻¹, 10 g), Jeffamine M-2070 (100 g) were dissolved in a mixture of DMF (50 mL) and toluene (50 mL) in a reaction flask. The flask was heated at reflux temperature under nitrogen gas for 72 h, any water present being removed from the reaction by means of azeotropic distillation and collection into a Dean-Stark apparatus. The resulting polymer solution was cooled and precipitated into hexane, the polymer recovered using filtration, and dried to remove traces of solvent. The product was studied using GPC and FTIR.

### Example 9

### Reaction of Poly(styrene-alt-maleic anhydride, ˜2K) with Jeffamine M-2070 Polyether Amine (Preparation of RP7)

Poly(styrene-alt-maleic anhydride) (SMA 1000, Mₙ: 2000 g mol⁻¹, 50 g) and Jeffamine M-2070 (500 g) were added to a reaction flask equipped with an overhead stirrer. The flask was placed under an atmosphere of nitrogen gas and heated to 160° C. When the vessel reached elevated temperature and the Jeffamine had reduced in viscosity agitation of the mixture commenced to obtain intimate mixing and therefore reaction of the two. After 24 h reaction the vessel was allowed to cool and the resulting polymer recovered. The product was studied using GPC and FTIR.

### Example 10

### Reaction of polybutadiene-graft-maleic anhydride with Jeffamine M-2070 Polyether Amine (Preparation of RP8) in a Reaction Flask

Poly(butadiene-graft-maleic anhydride (27 g, Lithene N4-9000-10MA) and Jeffamine M-2070 (105 g, purchased from Clariant), were weighed out and added to a reaction flask with a 1 L capacity, equipped with an overhead stirrer. A flow of nitrogen gas was passed through the vessel, which was then heated to 120° C. using an oil bath. Stirring of the molten mixture then commenced and the exterior of the flask was heated to 155° C. The reaction mixture was maintained at this temperature for a total of approximately 72 hours. Following this it was allowed to cool to room temperature and recovered. The product was studied using GPC and FTIR.

### Example 11

### Reaction of Poly(butadiene-graft-maleic anhydride) with Methoxy Poly(ethylene oxide) 2K (Preparation of RP9) in a Reaction Flask

Polymer RP9 was synthesized in the same manner as polymer RP8 using poly(butadiene-graft-maleic anhydride (35 g, Lithene N4-9000-10MA) and methoxy poly(ethylene oxide) (Mₙ: 2000 g mol-1, 136 g) as the graft. The product was studied using GPC and FTIR.

### Example 12

### Reaction of Poly(isoprene-graft-maleic acid monomethyl ester) with Jeffamine M-2070 Polyether Amine (Preparation of RP10) in a Reaction Flask

Poly(isoprene-graft-maleic acid methyl ester) (200 g, LIR-410) and Jeffamine M-2070 (95 g, purchased from Clariant), were weighed out and added to a reaction flask with a 1 L capacity, equipped with an overhead stirrer. A flow of nitrogen gas was passed through the vessel, which was then heated to 80° C. using an oil bath. Stirring of the molten mixture then commenced and the exterior of the flask was heated to 160° C. The reaction mixture was maintained at this temperature for a total of approximately 48 hours. Following this it was allowed to cool to room temperature and recovered. The product was studied using GPC and FTIR.

### Example 13

### Reaction of Poly(isoprene-graft-maleic acid monomethyl ester) with Jeffamine M-2070 Polyether Amine (Preparation of RP10) in a Reaction Flask

Poly(isoprene-graft-maleic acid methyl ester) (200 g, LIR-410) and Jeffamine M-2070 (95 g) were weighed out and added to a reaction flask with a 1 L capacity, equipped with an overhead stirrer. A flow of nitrogen gas was passed through the vessel, which was then heated to 80° C. using an oil bath. Stirring of the molten mixture then commenced and the exterior of the flask was heated to 160° C. The reaction mixture was maintained at this temperature for a total of approximately 48 hours. Following this it was allowed to cool to room temperature and recovered.

The product was studied using GPC and FTIR.

### Example 14

### Reaction of Poly(isoprene-graft-maleic anhydride) with Jeffamine M-2070 Polyether Amine (Preparation of RP11) in a Reaction Flask

Poly(isoprene-graft-maleic anhydride) (470 g, LIR-403) Jeffamine M-2070 (75 g) were weighed out and added to a flanged reaction flask, equipped with an overhead stirrer. A flow of nitrogen gas was passed through the vessel, which was then heated to 80° C. using an oil bath. Stirring of the molten mixture then commenced and the exterior of the flask was heated to 160° C. The reaction mixture was maintained at this temperature for a total of approximately 16 hours. Following this it was allowed to cool to room temperature and recovered. The product was studied using GPC and FTIR.

### Example 15

### Determination of Molecular Weights of Polymeric Materials

The polymer samples were analyzed using a PL-GPC50plus GPC system manufactured by Polymer Labs. The following conditions were used:

Eluent: THF stabilised with 250 ppm BHT

### Eluent RI: 1.408

Flow Rate (ml/min): 1

### Temperature: 40° C.

### Column Set Name: 2 Columns 30 mm PL gel 5 um MIXED-D

### Detector Name: DRI

### Detector Calibration Curve: Polystyrene Standards (538 Da-265000 Da)

Samples of the amphiphilic graft copolymers were dissolved in THF and injected into the GPC apparatus.

This technique was used to confirm the structure and determine the molecular weights of all of the copolymers (Table 2). The number average molecular weight (Mₙ), weight average molecular weight (M_{w}) and dispersity ( [symbol] _{M}, also known as polydispersity index or PDI) were recorded for all samples.

TABLE 2
GPC Data for Amphiphilic Graft Copolymers

| Polymer | Mₙ | M_{w} | [symbol] _{M} |
|---|---|---|---|
| RP1 | 2930 | 4140 | 1.4 |
| RP2 | 11420 | 13410 | 1.2 |
| RP3 | 17878 | 20710 | 1.2 |
| RP4 | 10640 | 22900 | 2.2 |
| RP5 | 34110 | 49740 | 1.5 |
| RP6 | 19800 | 22030 | 1.1 |
| RP7 | 30780 | 38210 | 1.2 |
| RP8 | 32880 | 35860 | 1.1 |
| RP9 | 24350 | 26150 | 1.1 |
| RP10 | 29770 | 34750 | 1.2 |
| RP11 | 37600 | 49360 | 1.3 |

### Example 16

### Determination of Degrees of Grafting with PEO or Polyether Amine Using FT-IR

The analysis was carried out on a PerkinElmer Paragon 2000 Infrared spectrometer. Samples for analysis were dissolved in spectrometric grade chloroform and placed in a liquid cell (Barium fluoride plates separated by PTFE spacer) in a mounting bracket/carriage in an IR beam with known cell path length.

A sample of the batch of the backbone used to synthesize the graft copolymer was accurately weighed out ˜0.1 g (+/−0.05 g) into the stoppered conical flask and dissolved in 10 g of accurately weighed out chloroform. The FT-IR of the sample was collected, and the percentage transmission values measured at 1830 cm⁻¹ and at 1790 cm⁻¹ recorded. The sample of the final graft copolymer was accurately weighed out ˜1.5 g (+/−0.5 g) into the stoppered conical flask, dissolved in 10 g of accurately weighed out chloroform, and studied by FT-IR in a similar manner. The concentration of maleic anhydride in each sample was then calculated using the following formula:

$$µmole \text{/} g ( in sample ) = \frac{33600}{C} \times {Log}_{10} \frac{\% T ( at 1830.0 {cm}^{- 1} )}{\% T ( at 1790.0 {cm}^{- 1} )}$$

where C is the concentration in the test solution (quoted in mg g⁻¹). The percentage conversion of maleic anhydride can then be determined by comparing the values from the backbone and graft copolymer.

In general the grafting of MPEO onto the backbone is confirmed by observing changes in the region 1550-1850 cm⁻¹ associated with the maleic anhydride units and resulting species formed on reaction with poly(ethylene oxides) and polyether amines.

### Formulation of the Amphiphilic Graft Copolymers into the Latex of the Invention

### Example 17

### Preparation of Latex from Oil Phase Based on Solution of Polymer—Direct Method

Latex sample RL1 was prepared in the following manner: Polymer RP11 (30 g) was dissolved in cyclohexane (70 g) to make a 30 weight % solution of polymer. A 5 weight % solution of DOSS was made by dissolving DOSS (5 g) in water (95 g). DOSS solution (55.65 g), BYK022 (7.5 g) and DI water (149.91 g) were added into a glass flanged reactor flask and the mixture was vigorously stirred by means of an overhead stirrer equipped with an anchor stirrer head. To this a 30% solution of RP11 in cyclohexane (86.94 g) was added slowly over the course of an hour. The resulting mixture was then stirred for a further two hours. The latex sample was then placed in a round bottom flask and the cyclohexane solvent removed from the sample under vacuum on a rotary evaporator. The resulting latex was stable and did not phase separate.

In a similar manner RL2 was prepared using a 30 weight % solution of RP11 in chloroform; RL3 was prepared using a 30 weight % solution of RP11 in methyl ethyl ketone and RL4 was prepared using a 30 weight % solution of RP11 in acetone.

### Example 18

### Preparation of Latex from Oil Phase Based on Solution of Polymer on a Larger Scale—Direct Method

Latex sample RL5 was prepared in the following manner. Polymer RP11 (130 g) was dissolved in chloroform (304 g) to make a 30 weight % solution of polymer. A 5 weight % solution of DOSS was made by dissolving DOSS (14 g) in water (264 g). DOSS solution (278 g), BYK-022 (38 g) and DI water (750 g) were added into a 2 L beaker and the mixture was vigorously stirred by means of a Silverson laboratory homogeniser (8000 rpm) for 5 min to ensure uniformity. To this a 30% solution of RP11 in chloroform (435 g) was added slowly over the course of 30 min. The resulting mixture was then stirred for a further two hours at 8000 rpm. The latex sample was sparged overnight to remove residual chloroform. The resulting latex was stable and did not phase separate.

### Example 19

### Preparation of RP11 Latex using Surfactant Blends—Direct Method

Latex sample RL6 was prepared in the following manner. A mixture of polymer RP11 (47 g), DOSS surfactant (5.5 g) and BYK-022 (2.7 g) was added to a flanged reactor flask equipped with an overhead stirrer with anchor head. The mixture was placed under a blanket of nitrogen and heated to 90° C. to melt the polymer. The powdered DOSS was dispersed in the polymer by agitating the mixture for 30 min, following which the resulting RP11/DOSS paste was allowed to cool and recovered from the reactor. DI water (294 g), DOSS (3.0 g) and BYK-022 (3.0 g) were added to a glass reactor and the mixture was heated to 80° C. with agitation from an overhead reactor equipped with a pitch blade. The polymer/surfactant paste (55 g) was transferred into a syringe that was heated to 80° C. Tubing was attached to the end of the syringe which was placed under the surface of the water close to the stirrer. The paste was then injected slowly into the water over the course of an hour and stirring was maintained for another hour afterwards at elevated temperature. After this the latex was allowed to cool to room temperature. The resulting latex was stable and did not phase separate.

Latex RL7 was prepared in a similar manner by adding a paste, made from RP11 polymer (70 g) and Neodol 91-8 (35 g), to BYK-022 (4 g) dissolved in 1% DOSS solution (210 g).

### Example 20

### Preparation of RP11 Latex Using Surfactant Blends—Inversion Method

Latex sample RL8 was prepared in the following manner. A mixture of polymer RP11 (40 g), DOSS surfactant (4.0 g) and BYK-022 (2.0 g) was added to a flanged reactor flask equipped with an overhead stirrer with anchor head. The mixture was placed under a blanket of nitrogen and heated to 80° C. to melt the polymer. The powdered DOSS was dispersed in the polymer by agitating the mixture for 30 min. The hot paste was then slowly stirred and a hot solution of DOSS (3.0 g) and BYK-022 (3.0 g) in DI water (294 g) was then slowly added to the mixture. An increase in viscosity is noted until the mixture inverts from water in oil to oil in water. The mixing speed was then increased and the remaining solution added over the course of 1 h. After addition was complete the mixture was stirred for another 1 h at elevated temperature before being allowed to cool to RT with continuous agitation. The resulting latex was stable and did not phase separate.

Latex RL9 was prepared in a similar manner by adding 1% DOSS aqueous solution (350 g) to a paste made from RP11 polymer (141 g), SDBS (11.5 g). Portions of BYK-022 (2×5.3 g) were added to the latex periodically during manufacture as required to suppress foaming.

Latex RL10 was prepared in a similar manner by adding DI water (175 g) to a paste made from RP11 polymer (12.5 g), SDBS (5 g) at room temperature.

Latex RL11 was prepared in a similar manner by adding DI water (30 g) to a paste made from RP11 polymer (2 g), Neodol 25-7 (1 g) at room temperature.

Latex RL12 was prepared in a similar manner by adding 1% DOSS aqueous solution (30 g) to a paste made from RP11 polymer (2 g), Neodol 25-7 (1 g) at room temperature.

### Example 21

### Preparation of RP11 Latex from Neat Polymer—Inversion Method

Latex sample RL13 was prepared in the following manner. Polymer RP11 (10 g) was added to a flanged reactor flask equipped with an overhead stirrer with anchor head. The mixture was placed under a blanket of nitrogen and heated to 90° C. Stirring commenced and a hot solution of SDBS (25 g) in DI water (75 g) was then slowly added to the mixture over the course of about 1 h. After addition was complete the mixture was stirred overnight at elevated temperature before being allowed to cool to RT with continuous agitation. The resulting latex was stable and did not phase separate.

Latex RL14 was prepared in a similar manner by adding 5% aqueous DOSS solution (106 g) to RP11 polymer (15.6 g). After addition was complete the mixture was stirred for another 2 h before being allowed to cool to RT with continuous agitation.

Latex RL15 was prepared in a similar manner by adding 10% aqueous Synperonic 91-8 solution (125 g) to RP11 polymer (17.5 g) at 85° C. After addition was complete the mixture was stirred for another 2 h before being allowed to cool to RT with continuous agitation.

Latex RL16 was prepared in a similar manner by adding 10% aqueous Synperonic 91-8 solution (605 g) to RP11 polymer (110 g) at 85° C. After addition was complete the mixture was stirred for another 2 h before being allowed to cool to RT with continuous agitation.

Latex RL17 was prepared in a similar manner by adding 5% aqueous DOSS solution (83 g) to a mixture of RP11 polymer (15 g) and Synperonic NCA 810 at 85° C. After addition was complete the mixture was stirred for another 1 h before being allowed to cool to RT with continuous agitation.

### Example 22

### Preparation of RP11 Latex from Neat Polymer—Direct Method

Latex sample RL18 was prepared in the following manner. DOSS (10.5 g) and BYK-022 (5.0 g) were added to DI water (199 g) in a flanged reactor flask equipped with an overhead stirrer with anchor head. The mixture was placed under a blanket of nitrogen and heated to 80° C. RP11 polymer (45 g) was placed in a jacketed dropping funnel which was heated to 80° C. The hot polymer was slowly added to the stirred surfactant solution over the course of about 1 h. After addition was complete the mixture was stirred for another 2 h at elevated temperature before being allowed to cool to RT with continuous agitation. The resulting latex was stable and did not phase separate.

To illustrate the invention samples of polymer RL1, RL2, RL4, RL9, RL11, RL12, RL15 and RL16 were formulated into HSC formulations.

Formulation of the Amphiphilic Graft Copolymers into Hard Surface Cleaners for Industrial and Institutional Use

To illustrate the invention amphiphilic graft copolymers were formulated with a hard surface cleaning preparation (Desguard 20) intended for use in industrial and institutional environments. Surfactant Envirogem 360 was added to all the samples including controls to ensure better wetting onto the tiles and therefore more accurate and reproducible analytical data.

### Example 23

### Preparation of INI Hard Surface Cleaner Based on Desguard 20 and RP3-RF1

| | % w/w | |
|---|---|---|
| Desguard 20 | 7.34 | 3.67 |
| RP3 | 1.00 | 0.50 |
| EnviroGem 360 | 1.00 | 0.50 |
| DI Water | 90.66 | 45.33 |
| | 100.00 | 50.00 |

Desguard 20 (3.7 g) was charged to a glass bottle equipped with a magnetic follower and stirring commenced using a magnetic stirrer. Polymer RP3 (0.5 g) was added to the formulation which was stirred until homogenous. EnviroGem 360 (0.5 g) was then added to the mixture which was left stirring for 10 min. After this the solution was let down with DI water (45 g) to the desired concentration.

### Example 24

### Preparation of INI Hard Surface Cleaner Based on Desguard 20 and RP7-RF2 MP14/160/5

| | % w/w | |
|---|---|---|
| Desguard 20 | 7.34 | 3.67 |
| RP7 | 1.00 | 0.50 |
| EnviroGem 360 | 1.00 | 0.50 |
| DI Water | 90.66 | 45.33 |
| | 100.00 | 50.00 |

Desguard 20 (3.7 g) was charged to a glass bottle equipped with a magnetic follower and stirring commenced using a magnetic stirrer. Polymer RP7 (0.5 g) was added to the formulation which was stirred until homogenous. EnviroGem 360 (0.5 g) was then added to the mixture which was left stirring for 10 min. After this the solution was let down with DI water (45 g) to the desired concentration.

### Example 25

### Preparation of INI Hard Surface Cleaner Based on Desguard 20 and Latex Containing RP11-RF3

| | % w/w | |
|---|---|---|
| Desguard 20 | 7.34 | 3.67 |
| RL5 11 Latex | 8.02 | 4.01 |
| EnviroGem 360 | 1.00 | 0.50 |
| DI Water | 83.64 | 41.82 |
| | 100.00 | 50.00 |

Desguard 20 (3.7 g) was charged to a glass bottle equipped with a magnetic follower and stirring commenced using a magnetic stirrer. Polymer latex RL5 (4.0 g) containing polymer RP11 was added to the formulation which was stirred until homogenous. EnviroGem 360 (0.5 g) was then added to the mixture which was left stirring for 10 min. After this the solution was let down with DI water (41.8 g) to the desired concentration.

### Example 26

### Desguard Control—Preparation of INI Hard Surface Cleaner Based on Desguard 20

| | % w/w | |
|---|---|---|
| Desguard 20 | 7.34 | 3.67 |
| EnviroGem 360 | 1.00 | 0.50 |
| DI Water | 91.66 | 45.83 |
| | 100.00 | 50.00 |

Desguard 20 (3.7 g) was charged to a glass bottle equipped with a magnetic follower and stirring commenced using a magnetic stirrer. EnviroGem 360 (0.5 g) was then added to the formulation which was left stirring for 10 min. After this the solution was let down with DI water (45.8 g) to the desired concentration.

### Example 27

### Measurement of Gloss from Hard Surface Cleaning Formulations

Materials used in testing were typically obtained from suppliers of building materials or similar and treated to make them appropriate and fair test substrates. For instance vinyl tiles intended for use as flooring were cut to a 150×150 mm size, cleaned with water, degreased using ethanol, then allowed to dry prior to use.

Gloss values were measured using an Elcometer 407 Statistical Gloss Meter. A total of 9 separate measurements are recorded at different locations on the substrate and an average of the values is calculated by the gloss meter.

Gloss values for the uncoated substrate are recorded. Cleaning solution (1.5 mL) is evenly pipetted along one edge of the substrate and a 12 μm wire wound bar is used to apply the cleaning solution to it. The film of cleaning solution is allowed to dry for at least 20 min and the gloss is then re-measured. This process is carried out a further two times, to give a total of 3 applications of the cleaning solution.

In the instance of the vinyl tiles the gloss values recorded at an angle of 85° were recorded. The value quoted is the 85° Delta(Δ) gloss calculated using the following equation:

85°ΔGloss=Gloss after application of the cleaning solution−bare tile gloss

To illustrate the invention the polymers formulated with Desguard 20 cleaning preparation were applied to vinyl tiles and the gloss of the resulting tiles analysed (Table 3).

TABLE 3
Gloss Uplift (ΔGloss at 85°) on Vinyl Tiles

| | | ΔGloss (85 Degree) | | |
|---|---|---|---|---|
| Polymer | Latex | 1st Coat | 2nd Coat | 3rd Coat |
| N/A Control | N/A | 0.3 | 1.2 | 2.2 |
| RP3 | N/A | 1.7 | 3.7 | 5.8 |
| RP7 | N/A | 1.3 | 2.8 | 4.1 |
| RP11 | RL5 | 1.9 | 4.0 | 7.1 |

Application of the Desguard control formulation was found to increase levels of gloss on the vinyl tile to some degree, likely due to the surfactants or other ingredients present in the formulation. Significantly greater increases in performance were observed in the case of the formulations formulated with the amphiphilic graft copolymers. The best performance was noted from the formulation containing polymer RP11. Thus the consumer would be expected to enjoy enhanced gloss from any formulations with the polymers in them.

Various modifications and variations of the described methods of the invention will be apparent to those skilled in the art without departing from the scope and spirit of the invention. Although the invention has been described in connection with specific preferred embodiments, various modifications of the described modes for carrying out the invention which are obvious to those skilled in the relevant or related fields are intended to be within the scope of the following claims.

1. A latex composition comprising a dispersion of an amphiphilic copolymer in aqueous medium, wherein the amphiphilic copolymer is:
(i) a graft copolymer comprising a hydrophobic straight or branched chain carbon-carbon backbone having at least one hydrophilic side chain, wherein each hydrophilic side chain is independently of formula (I), 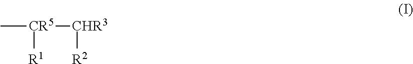
wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II) 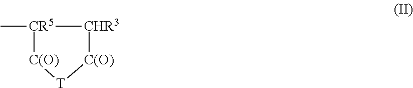
wherein:
R³ and R⁵ are each independently H or alkyl;
W is O or NR⁴;
Q is a group of formula —X—Y—X²P;
T is a group of formula —N—Y—X²—P;
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group; or
(ii) an amphiphilic graft copolymer of general formula (I′):
B—(OR′)x (I′)
wherein B is a straight or branched chain polymer backbone which is a copolymer of at least one ethylenically-unsaturated hydrocarbon monomer comprising at least 2 carbon atoms and maleic anhydride, and each OR′ is a hydrophilic side chain attached to the backbone, wherein x denotes the number of side chains and is in the range 1 to 5000.

2. A latex composition according to claim 1 wherein the amphiphilic graft copolymer has from about 1 to about 5000.

3. A latex composition according to claim 1 wherein the hydrophilic polymeric group Y is a polyalkylene oxide, polyglycidol, poly(vinyl alcohol), poly(ethylene imine), poly(styrene sulphonate) or poly(acrylic acid).

4. A latex composition according to claim 1 wherein the hydrophilic polymeric group Y is of formula -(Alk¹-O)_{b}-(Alk²-O)_{c}—, wherein Alk¹ and Alk² are each independently an alkylene group having from 2 to 4 carbon atoms, and b and c are each independently an integer from 1 to 125; provided that the sum of
b+c has a value in the range of from about 10 to about 600.

5. A latex composition according to claim 1 wherein the carbon-carbon backbone is derived from a homopolymer of an ethylenically-unsaturated polymerizable hydrocarbon monomer or from a copolymer of two or more ethylenically-unsaturated polymerizable hydrocarbon monomers.

6. A latex composition according to claim 5 wherein the carbon-carbon backbone is derived from ethylene, isobutylene, 1,3-butadiene, isoprene, styrene, a C10-C20 terminal alkene, such as octadecene, or a mixture thereof.

7. A latex composition according to claim 1 wherein the carbon-carbon backbone has maleic anhydride, maleic acid or salts thereof or maleic acid ester or salts thereof or a mixture thereof grafted thereto.

8. A latex composition according to claim 7 wherein the carbon-carbon backbone comprises from about 1 to about 50 wt % maleic anhydride

9. A latex composition according to claim 1 wherein the amphiphilic copolymer is prepared by reacting a compound of formulae (III), (IX) or (X), 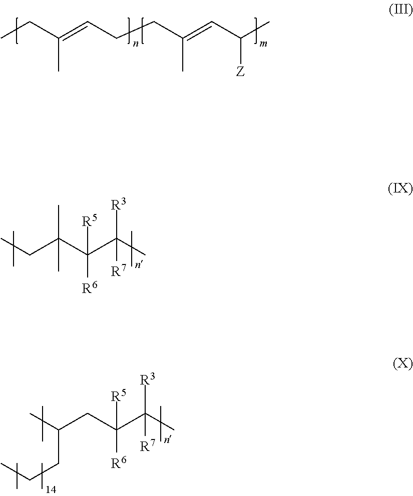
wherein Z is a group of the formula (IV), 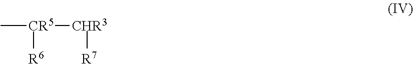
wherein R³ and R⁵ are each independently H or alkyl, and R⁶ and R⁷ are each independently H or an acyl group, provided that at least one of R⁶ and R⁷ is an acyl group, or R⁶ and R⁷ are linked to form, together with the carbon atoms to which they are attached, a group of formula (V), 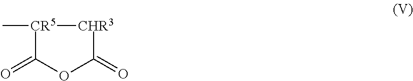
where n and m are each independently an integer from 1 to 20000 and n′ is an integer from 5 to 4000;
with a side chain precursor of formula (VI)
HX¹—Y—X²P (VI)
wherein:
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

10. A latex composition according to claim 1 wherein the amphiphilic copolymer is prepared by reacting a compound of formula formulae (IIIa), (IXa) or (Xa), 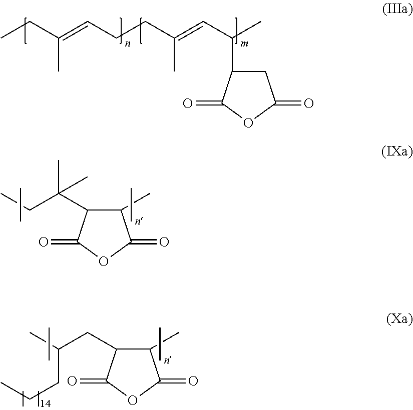
where n, n′ and m are each independently an integer from 1 to 20000 and n′ is an integer from 5 to 4000, with a side chain precursor of formula
(IV) HX¹—Y—X²P (VI)
wherein:
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

11. A latex composition according to claim 1 wherein the amphiphilic copolymer is prepared by reacting a polymer precursor of formula formulae (Nib), (IXb) or (Xb), 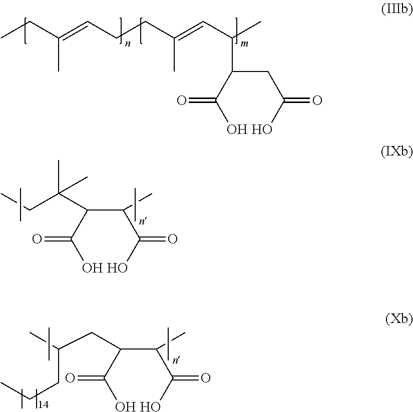
where n, n′ and m are each independently an integer from 1 to 20000 and n′ is an integer from 5 to 4000, with a side chain precursor of formula (VI)
(IV) HX¹—Y—X²P (VI)
wherein:
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

12. A latex composition according to claim 1 wherein the amphiphilic copolymer is prepared by reacting a polymer precursor of formulae (IIIc), (IXc) or (Xc), 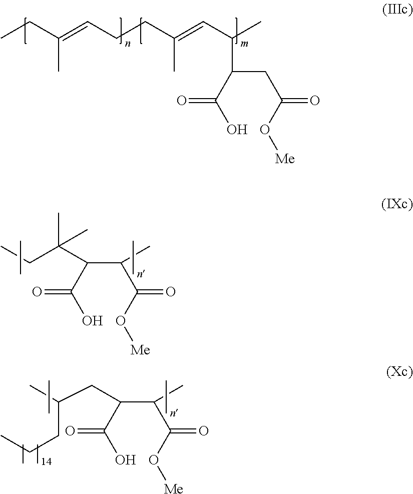
where n, n′ and m are each independently an integer from 1 to 20000 and n′ is an integer from 5 to 4000, with a side chain precursor of formula (VI)
(IV) HX¹—Y—X²P (VI)
wherein:
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group.

13. A latex composition according to claim 9 wherein said side chain precursor is of formula (VIa) 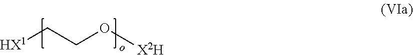
wherein X¹ is O or NH and X² is (CH₂)ₚ and o is an integer from 5 to 250.

14. A latex composition according to claim 9 wherein said side chain precursor is of formula (VIb) 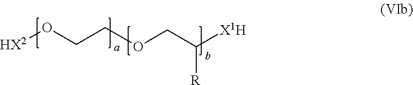
wherein R is H or alkyl, X¹ is O or NH and X² is CH₂ and the sum of a and b is an integer from 5 to 600.

15. A latex composition according to claim 9 wherein said side chain precursor is of formula (VIc) 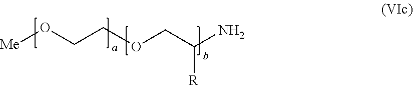
wherein R is H or alkyl and the sum of a and b is an integer from 5 to 250.

16. A latex composition according to claim 1 wherein the amphiphilic copolymer is of formula (VII): 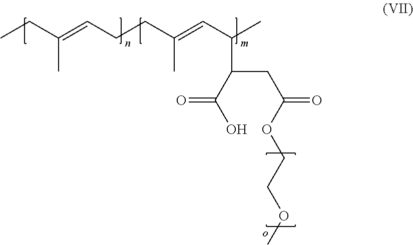
wherein each of m and n is independently an integer from 1 to 20000 and o is an integer from 5 to 600.

17. A latex composition according to claim 1 wherein the amphiphilic copolymer is of formula (VIII): 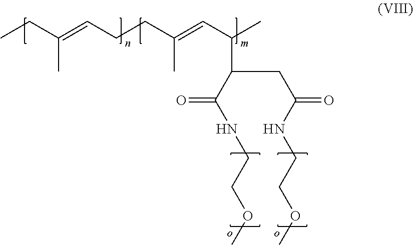
wherein each of m and n is independently an integer from 1 to 20000 and o is an integer from 5 to 600.

18. A latex composition according to claim 1 wherein the amphiphilic graft copolymer is of general formula (I′):
B—(OR′)ₓ (I′)
wherein B is a straight or branched chain polymer backbone which is a copolymer of at least one ethylenically-unsaturated hydrocarbon monomer comprising at least 2 carbon atoms and maleic anhydride and each OR′ is a hydrophilic side chain attached to the backbone, wherein x denotes the number of side chains and is in the range 1 to 5000.

19. A latex composition according to claim 18 wherein the carbon-carbon backbone is a copolymer of:
(i) maleic anhydride, maleic acid or salts thereof or maleic acid ester or salts thereof or a mixture thereof; and
(ii) one or more ethylenically-unsaturated polymerizable monomers.

20. A latex composition according to claim 19 wherein the ethylenically-unsaturated polymerizable monomer is ethylene, isobutylene, 1,3-butadiene, isoprene, styrene, a C₁₀-C₂₀ terminal alkene, such as octadecene, or a mixture thereof.

21. A latex composition according to claim 19 wherein the carbon-carbon backbone is an alternating copolymer of maleic anhydride, maleic acid or salts thereof or maleic acid ester or salts thereof and the ethylenically-unsaturated polymerizable monomer.

22. A latex composition according to claim 19 wherein the copolymer backbone is selected from:
poly(isobutylene-alt-maleic anhydride) (PIB-alt-MA): 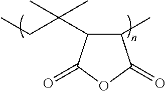
wherein n is between 5 and 4000;
poly(maleic anhydride-alt-1-octadecene) (C18-alt-MA) 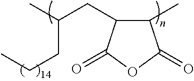
wherein n is between 5 and 500; and
poly(styrene-alt-maleic anhydride) (PS-alt-MA: 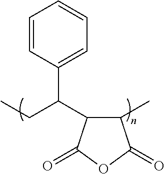
wherein n is between 5 and 500.

23. A latex composition according to claim 1 wherein the amphiphilic copolymer is present in an amount of from about 0.1 to about 50% by weight.

24. A latex composition according to claim 1 which further comprises one or more of the following: a surfactant, an organic solvent, a defoaming agent, a wetting agent, an antimicrobial agent, an antioxidant, a buffering agent, a neutralising agent, a plasticizer and a stabilizer.

25. A process for preparing a latex composition according to claim 1, said process comprising the addition of the amphiphilic copolymer to an aqueous solution, optionally in the presence of one or more surfactants.

26. A process for preparing a latex composition according to claim 1, said process comprising the addition of an aqueous solution to the amphiphilic copolymer, optionally in the presence of one or more surfactants.

27. A process according to claim 25 wherein the amphiphilic copolymer is dissolved in an organic solvent.

28. A latex composition comprising a dispersion of an amphiphilic copolymer in an aqueous medium, wherein the amphiphilic copolymer is:
(i) a graft copolymer comprising a hydrophobic straight or branched chain carbon-carbon backbone having at least one hydrophilic side chain, wherein each hydrophilic side chain is independently of formula (I), 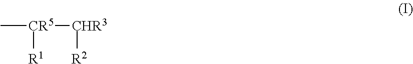
wherein R¹ and R² are each independently H, —C(O)WR⁴ or —C(O)Q;
provided that at least one of R¹ and R² is the group —C(O)Q;
or R¹ and R² together form a cyclic structure together with the carbon atoms to which they are attached, of formula (II) 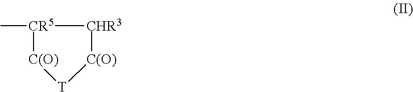
wherein:
R³ and R⁵ are each independently H or alkyl;
W is O or NR⁴;
Q is a group of formula —X¹—Y—X²P;
T is a group of formula —N—Y—X²—P;
X¹ is O, S or NR⁴;
X² is O, S, (CH₂)ₚ or NR⁴;
p is 0 to 6;
each R⁴ is independently H or alkyl;
P is H or another backbone; and
Y is a hydrophilic polymeric group; or
(ii) an amphiphilic copolymer of general formula (Γ):
B—(OR′)ₓ (Γ)
wherein B is a straight or branched chain polymer backbone which is a copolymer of at least one ethylenically-unsaturated hydrocarbon monomer comprising at least 2 carbon atoms and maleic anhydride and each OR′ is a hydrophilic side chain attached to the backbone, wherein x denotes the number of side chains and is in the range 1 to 5000; as an additive in a hard surface cleaning composition for industrial and institutional use.
